(19) United States
(12) Patent Application Publication
(10) Pub. No.: US 2014/0207812 A1
(43) Pub. Date: Jul. 24, 2014

(54) METHODS AND APPARATUS FOR COLLECTING ELECTRONICALLY STORED INFORMATION

(71) Applicant: KCura Corporation, Chicago, IL (US)

(72) Inventors: Michael Alan Bean, Portland, OR (US); Donald John Frey, Gresham, OR (US); Benjamin Sterling Jones, Beaverton, OR (US)

(73) Assignee: KCura Corporation, Chicago, IL (US)

(21) Appl. No.: 14/162,714

(22) Filed: Jan. 23, 2014

Related U.S. Application Data
(60) Provisional application No. 61/755,926, filed on Jan. 23, 2013.

(51) Int. Cl. G06F 17/30

(52) U.S. Cl. CPC G06F 17/30386
USPC 707/758

(57) ABSTRACT

Methods and apparatus for collecting electronically stored information are disclosed. In general, a processor images an electronic device to collect metadata associated with a plurality of files stored on the electronic device. For example, the metadata may include file names, file sizes dates, etc. The processor then receives selection information associated with the metadata, the selection information being indicative of a subset of the plurality of files. The processor then installs an electronically stored information (ESI) collection application (e.g., remotely via a network and/or via a thumb drive exclusively in RAM) in the first electronic device (e.g., a device running one of several different operating systems) in response to a selection of a collection initiation trigger (e.g., selection of a hyperlink or virtual button). The processor then collects the ESI. For example, the processor may collect the ESI from a hard disk or solid state drive using a collection wizard user interface. The processor then receives the subset of the plurality of files.

The present disclosure relates in general to electronically stored information and, in particular, to methods and apparatus for collecting electronically stored information.

### BACKGROUND

The modern business enterprise produces vast amounts of electronically stored information (ESI). For example, recent estimates indicate that over 89 billion business emails are sent throughout the world each day. ESI is typically stored throughout the enterprise on many different machines and across geographically diverse areas. Accordingly, the process of finding and collecting this information is time consuming, expensive, and subject to a host of potential problems.

In a typical collection process, custodians of data (usually individual employees) are identified as being relevant to a specific matter, and are accordingly included in the collection. There are three primary methods for collecting a custodian's ESI are: (1) physically collect the custodian's ESI onsite, directly from its computer; (2) remotely collect the custodian's ESI over a network via software agents; or (3) direct the custodian to “self-collect” its ESI and to then deliver it to a designated storage area.

While these methods are commonly used, none of them is perfect. For example, collecting ESI onsite is time-consuming, disruptive, and resource-intensive. An IT professional must travel to the custodian's physical location with specialized forensic collection equipment, which involves coordinating several schedules across the enterprise. This process temporarily blocks the custodian's access to its computer and interrupts its work activities. Further, an IT professional's physical presence may alert employees to an ongoing investigation, who may then attempt to destroy data to prevent its collection.

The next method, remote collection, is not nearly as disruptive as a physical collection. However, it requires significant effort from an organization's IT department. The department must ensure that the collection software is installed in advance on every computer or workstation used by employees. Further, it must manage this software remotely, which requires installing upgrades on potentially thousands of devices across the entire organization. Upgrades may require custodian consent before they are installed, and typically increase network usage while simultaneously decreasing network performance. Also, because installing or updating the software physically changes the Hard Drive Disk, there is a danger that the upgrade will overwrite information that otherwise could have been forensically recoverable.

Finally, the most problematic of the three methods is self-collection. Here, the custodian is tasked with manually identifying and collecting its ESI. Because it is impossible for the custodian to be neutral and unbiased when collecting its ESI, this technique has drawn criticism from judges and is rapidly becoming an unviable collection option.

In addition to these issues, commercial collection solutions suffer from many other limitations. First, most commercially available collection software tools are designed for highly-trained or certified IT professionals. They are not intuitive, and almost impossible to use by laypeople. Second, many applications do not allow a user to collect ESI from both Macs and PCs. This is impractical and inefficient in environments where custodians increasingly have data stored in both formats. Third, most tools are limited to only one collection method, such as remote or onsite. Fourth, many applications can only collect ESI from Hard Drive Disks and do not work, or are much less effective, with Solid State Drives. Fifth, no applications allow the custodian to participate in the collection process in a legally defensible manner. Finally, while many commercial collection solutions address some of these limitations, no product exists that solves all of them. For the business enterprise that must collect ESI for litigation or compliance, it must accept any number of several limitations, or cobble together several different tools in order to perform a proper collection.

Accordingly, there is a need in the art for a legal collection tool that allows an untrained user to collect ESI on any computer type, using any one of several workflows, and with the option to export their ESI to any location, all in a legally defensible manner.

### BRIEF DESCRIPTION OF THE DRAWINGS

FIG. 1 is a block diagram illustrating interactions between the EDMS and various entities

FIG. 2 is a flow diagram illustrating example processes for managing electronic discovery using the EDMS.

FIG. 3 is a flow diagram illustrating example processes for configuring the EDMS.

FIG. 4 is a flow diagram illustrating example processes for the EDMS facilitating and executing a legal hold.

FIG. 5 is a flow diagram illustrating example processes for the EDMS facilitating and executing a collection of discoverable information.

FIG. 6 illustrates one example of an interface through which information about current and past legal holds and collections may be viewed by a user.

FIGS. 7 and 8 illustrate example interfaces for configuring custodians and matters respectively.

FIG. 9 illustrates an example interface with a listing of legal holds, along with user interface elements for inspecting, deleting, and editing the legal holds

FIG. 10 shows an example interface with legal hold details, including name, effective dates, and a description

FIG. 11 shows an example interface where custodians may be added to a legal hold.

FIG. 12 illustrates user interface elements to create directives and questionnaires, as well as to inspect, edit, and delete existing directives and questionnaires.

FIG. 13, an example interface is shown for configuring information about a directive, including a description and a question to be posed to custodians receiving the directive

FIG. 14 shows an example interface where custodians may be added to receive the directive.

FIG. 15 illustrates an example interface for configuring information about a questionnaire, including a description and scheduling configuration, such as a time to send the directive, a frequency, and an end date.

FIG. 16 shows an example interface where questions may be added to the questionnaire.

FIG. 17 shows an example interface where custodians may be added to receive the questionnaire.

FIG. 18 shows an example interface for mailing the questionnaire.

FIG. 19 shows an example interface for selecting a custodian and source.

FIG. 20 shows an example interface describing a collection and providing user interface elements for facilitating execution of the scouting module on the custodian's computing device.

FIG. 21 shows an example interface for a custodian or for a user for executing the scouting module.

FIG. 22 illustrates an example dialog box asking a custodian or user whether they would allow execution of the scouting module on the custodian's computing device.

FIG. 23 illustrates example process dialogs showing execution of the scouting module on the custodian's computing device.

FIG. 24 shows an example interface showing collection information.

FIG. 25 shows an example interface for managing collection lists.

FIG. 26 shows an example interface for a custodian or for a user for executing the collection module.

FIG. 27 illustrates an example dialog box asking a custodian or user whether they would allow execution of the collection module on the custodian's computing device

FIG. 28 illustrates example process dialogs showing execution of the collection module on the custodian's computing device.

FIG. 29 illustrates an example save dialog for a user or custodian to save collected information locally to the custodian's computing device.

FIG. 30 shows an example interface of the EDMS showing that the collected information has been received. Next, the EDMS may extract the collection results.

FIG. 31 shows an example dialog box for a user entering an encryption password to view the collected information.

FIG. 32 shows an example dialog box for the user to select a location for saving the extracted collected information after decryption.

FIGS. 33 and 34 show example progress dialog boxes that show extraction progress.

FIG. 35 shows an example interface of a computing device to which the extracted collected information has been saved.

FIG. 36 shows an example computer suitable for use in accordance with various embodiments.

FIG. 37 illustrates an example non-transitory computer-readable storage medium having instructions configured to practice all or selected ones of the operations earlier described in accordance with various embodiments.

FIG. 38 shows an example legal hold screenshot.

FIG. 39 shows an example block diagram of certain elements of an example network communication system.

FIG. 40 is a block diagram of an example computing device.

FIG. 41 is an example flowchart of a method for collecting electronically stored information.

FIG. 42 is an example flowchart of a scout process.

FIG. 43 is an example flowchart of a collection process.

### DETAILED DESCRIPTION OF THE PREFERRED EMBODIMENTS

Apparatuses, methods and storage medium associated with management of electronic discovery. In various embodiments, an electronic discovery management system (“EDMS”) may be configured to facilitate the creation of legal holds, including the creation and sending of directives and/or questionnaires to custodians of discoverable information. In various embodiments, the EDMS may also be configured to provide for automated scouting of discoverable information from various sources that are under control (or otherwise associated with) custodians. The information obtained from the automated scouting may, in various embodiments, be utilized to configure an automated collection of discoverable information from the sources. In various embodiments, the EDMS may be configured to provide an interface for customization of legal holds, directives, questionnaires, scouting requests, collection of discoverable information, etc. Particular examples are described below.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

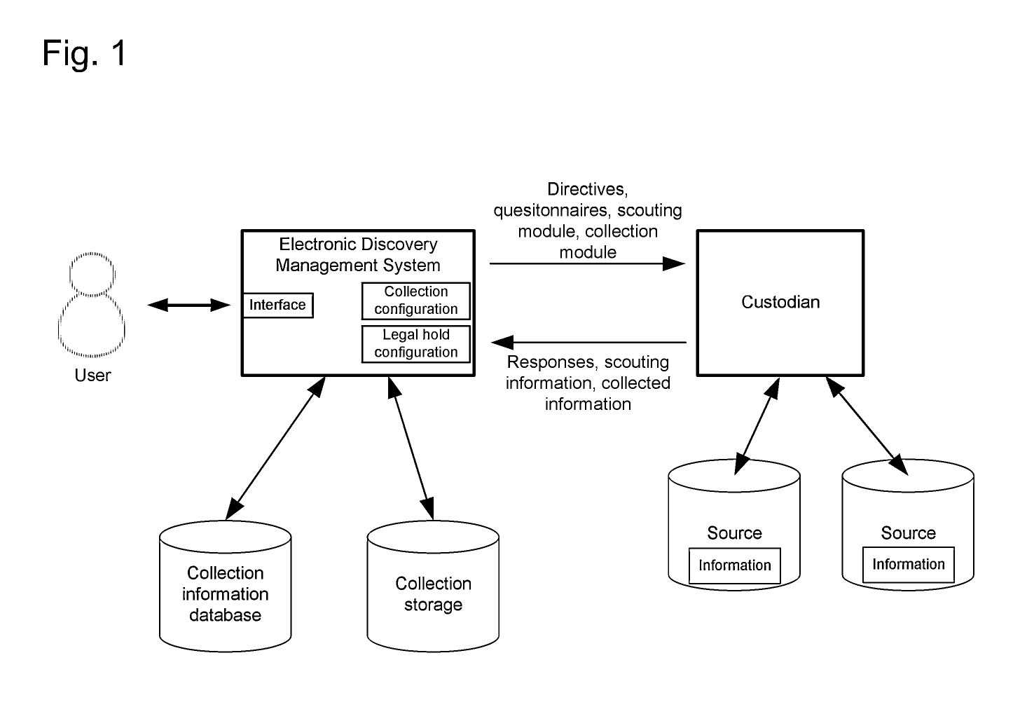

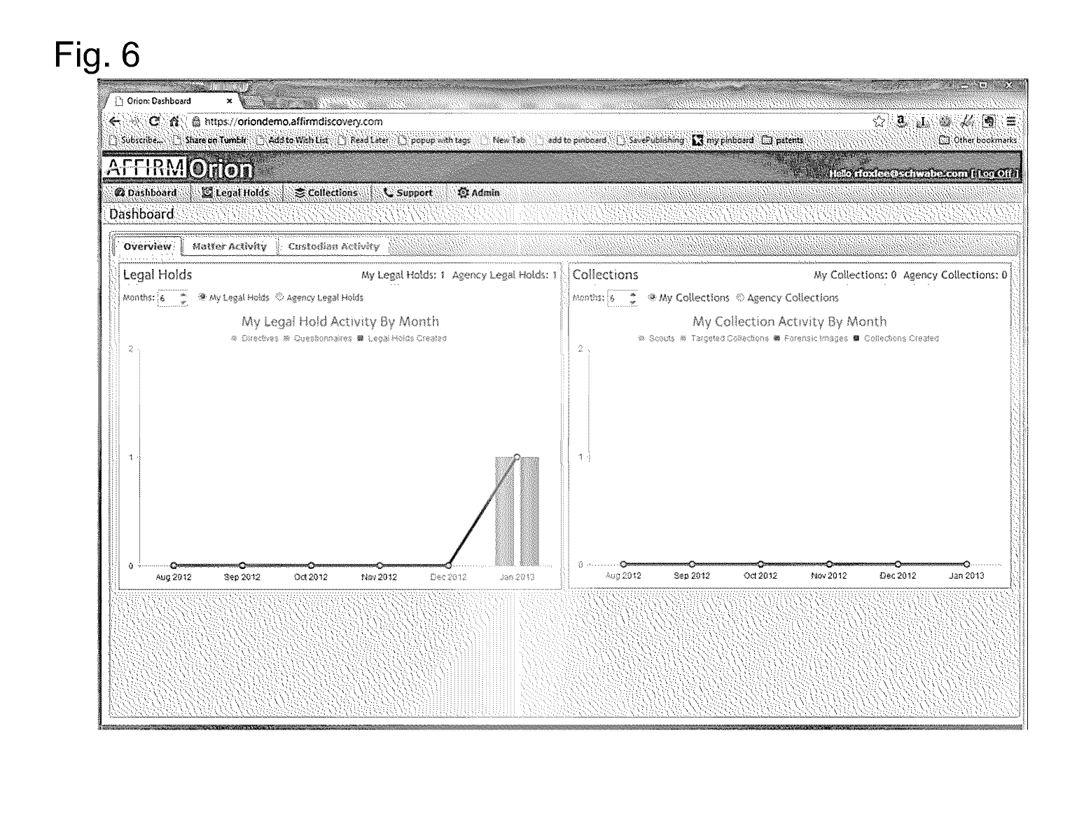

FIG. 1 is a block diagram illustrating interactions between the EDMS and various entities according to various embodiments. In various embodiments, a user may interact with the EDMS according to one or more interfaces to manage and/or customize various electronic discovery techniques described herein. In various embodiments, the interfaces may include web-based interfaces. Particular examples of such interfaces are provided herein, however, in other embodiments, different interfaces, both web-based and non-web-based may be used. FIG. 6 illustrates one example of an interface through which information about current and past legal holds and collections may be viewed by a user. In various embodiments, the interface of FIG. 6 may provide a customizable historical view of legal holds and collections as measured over time. Additional interface examples are described herein.

In various embodiments, the EDMS may interact with one or more custodians of discoverable information. In various embodiments, each custodian may have access to discoverable information on one or more sources, as illustrated. In various embodiments, these sources may be physically coupled to a computing device associated with the custodian or may be connected via other means, such as through a network. In various embodiments, the user may operate the EDMS may to deliver legal hold information to the custodians, such as, for example, directives and questionnaires to the custodian. In various embodiments, the EDMS may also deliver modules to be operated to acquire information from the custodian. In various embodiments, a scouting module may be delivered to the custodian which may be operated at the custodian to obtain information about discoverable documents that may be found on sources associated with the custodian. In various embodiments, a collection module may be delivered to the custodian which may be operated at the custodian to obtain discoverable information.

In various embodiments, the information obtained by the scouting module and/or the information collected by the collection module may be encrypted or otherwise protected such that it may not be viewed or otherwise accessed other than by entities authorized by the user and/or by the custodian. In various embodiments, the modules may comprise executable code that may execute on a local computing device of the custodian. In various embodiments, the modules may be delivered by downloading of the modules by the custodian, or by another entity. Particular examples of operation of the scouting and collection modules are described below. In various embodiments, the EDMS may have associated storage in which to store the obtained and/or collected information. For example, the EDMS may be associated with a collection information database which may be configured to store and process information obtained by the scouting module. In various embodiments, this information may include information such as, but not limited to, file types, filenames, file sizes, document location, storage structure, encryption information, etc. In another example, the EDMS may be associated with a collection storage which may be configured to store information collected by the collection module. In various embodiments, this information may include, but is not limited to documents of various types and/or storage structures.

In various embodiments, the EDMS may include one or more modules configured to operate to facilitate various operations described and illustrated herein. For example, the EDMS may include an interface module configured to provide the interface for the user. In another example, the EDMS may include a collection configuration module, which may be configured to facilitate configuration of the collection and scouting modules, as well as processing of information obtained and/or collected by those modules. In another example, the EDMS may include a legal hold configuration module, which may provide for configuration of legal holds, including directives and questionnaires. Particular examples of operations of these modules are described herein.

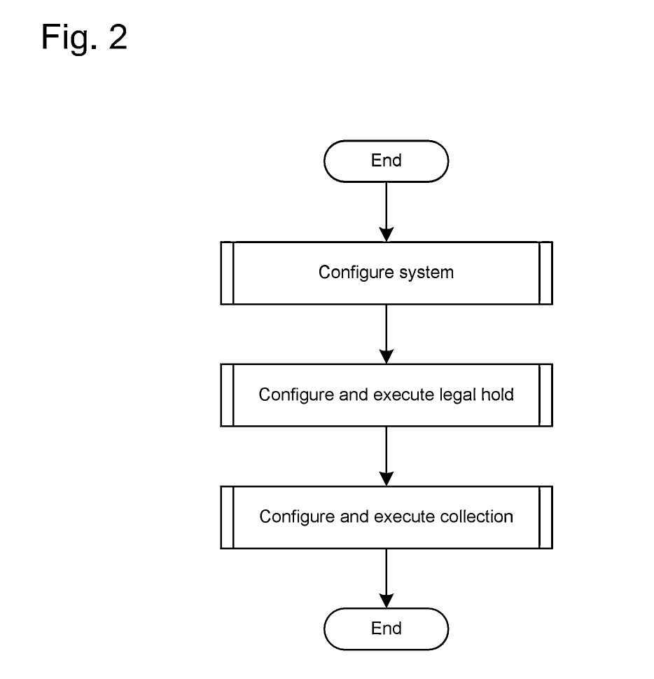

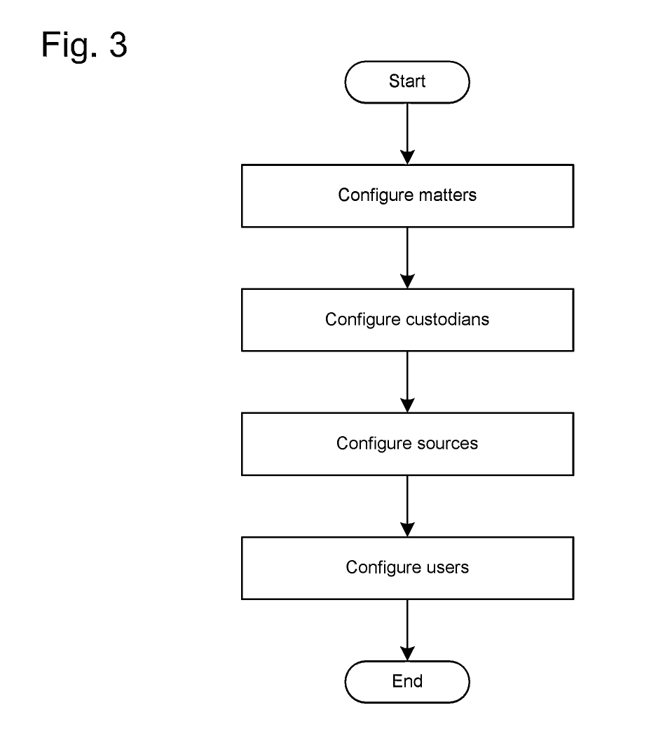

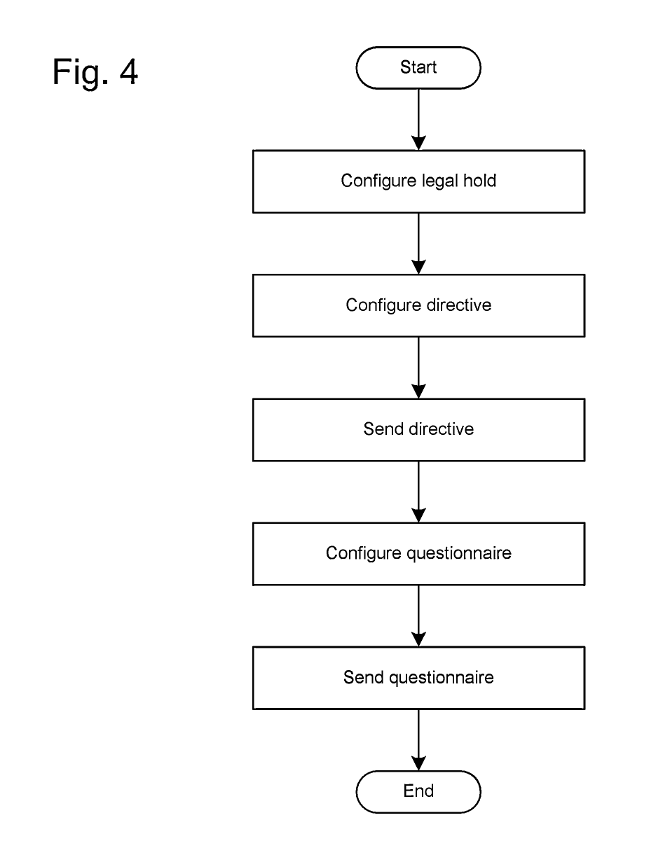

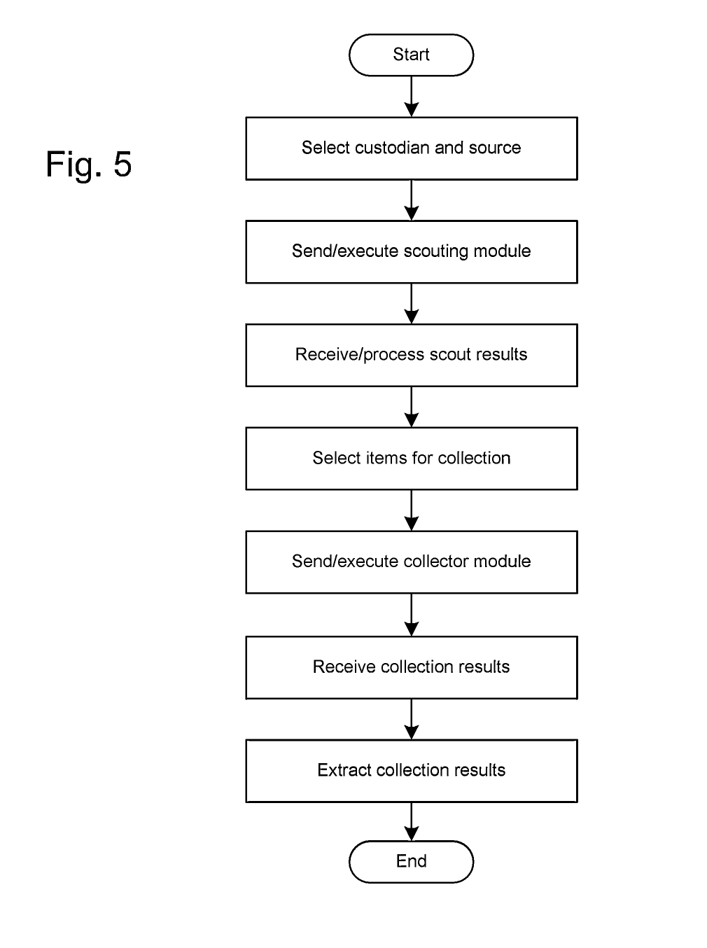

FIG. 2 is a flow diagram illustrating example processes for managing electronic discovery using the EDMS. While FIG. 2 illustrates a particular order of particular operations, in various embodiments, operations of FIG. 2 may be reordered, broken into additional operations, and/or omitted entirely. The process may begin where the EDMS may be configured for particular electronic discovery tasks. Particular examples of this configuration are described below with reference to FIG. 3. Next, the EDMS may facilitate configuration and execution of a legal hold. Particular examples of this configuration are described below with reference to FIG. 4. Next, the EDMS may facilitate the configuration and execution of collection of discoverable information. Particular examples of this configuration are described below with reference to FIG. 5.

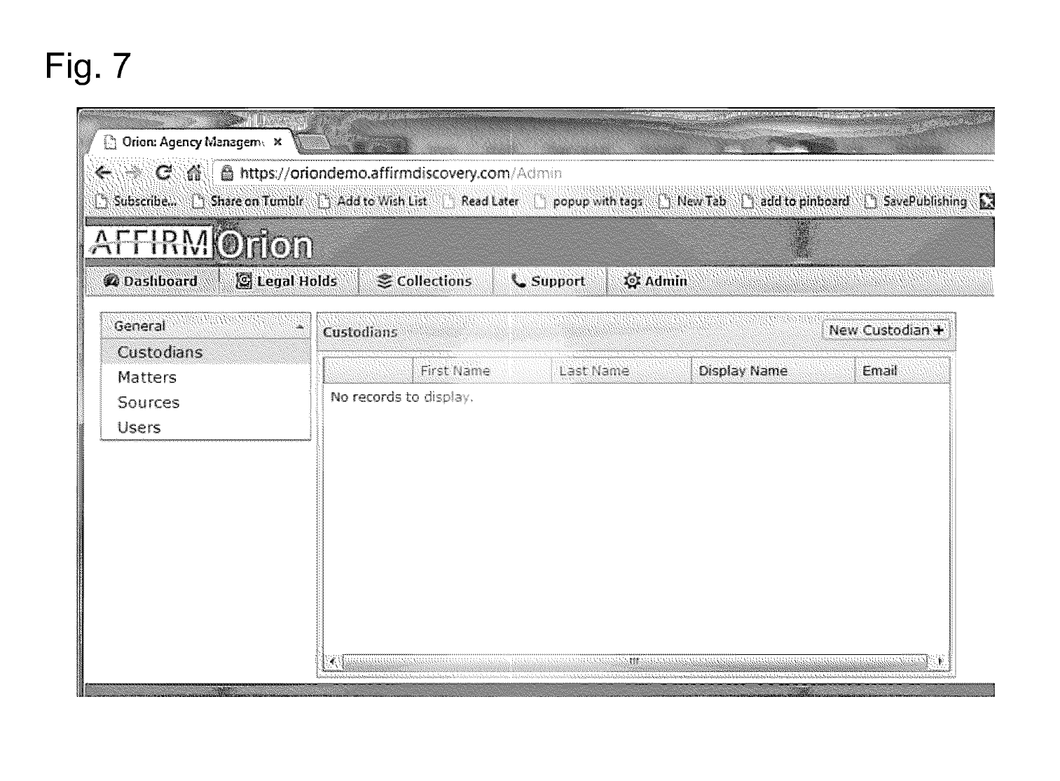

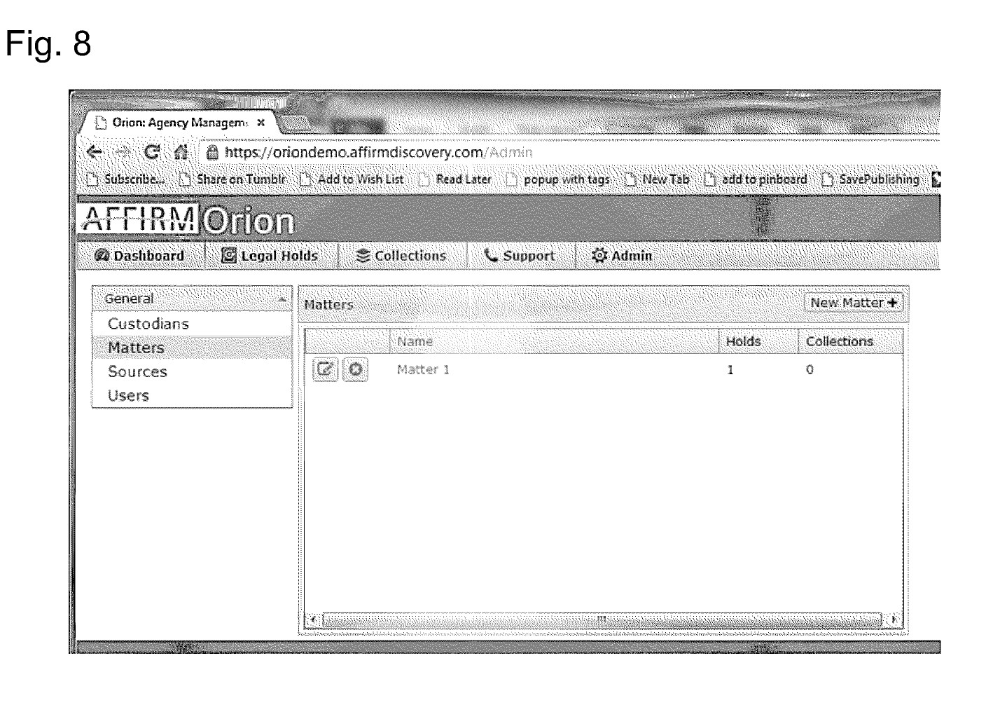

FIG. 3 is a flow diagram illustrating example processes for configuring the EDMS. While FIG. 3 illustrates a particular order of particular operations, in various embodiments, operations of FIG. 3 may be reordered, broken into additional operations, and/or omitted entirely. As illustrated, in the process of FIG. 3, matters, custodians, sources and users may be configured. In various embodiments, the configuration of matters, custodians, sources and/or users may include the creation of new matters, custodians, sources and/or users and/or the editing of information about current matters, custodians, sources and/or users. FIGS. 7 and 8 illustrate example interfaces for configuring custodians and matters respectively. In various embodiments and as illustrated, information may be entered by a user to update or create custodian and/or matter information, and currently-kept information may be viewed. Other interfaces may provide for configuration of sources and/or users.

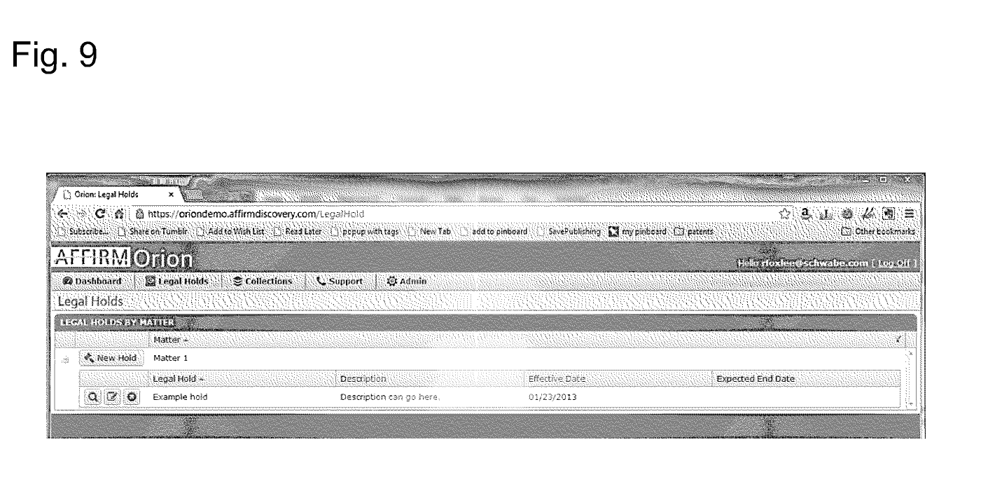

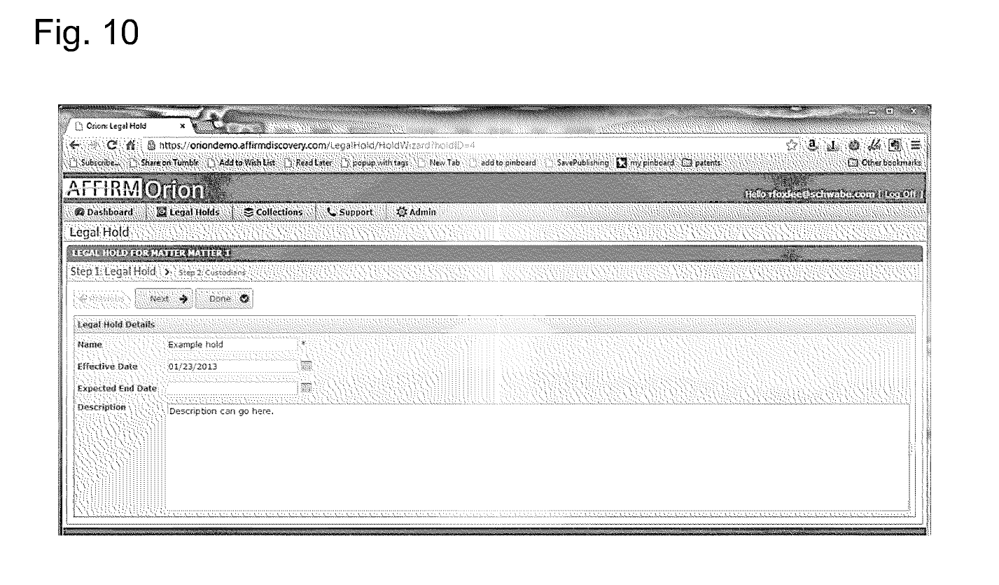

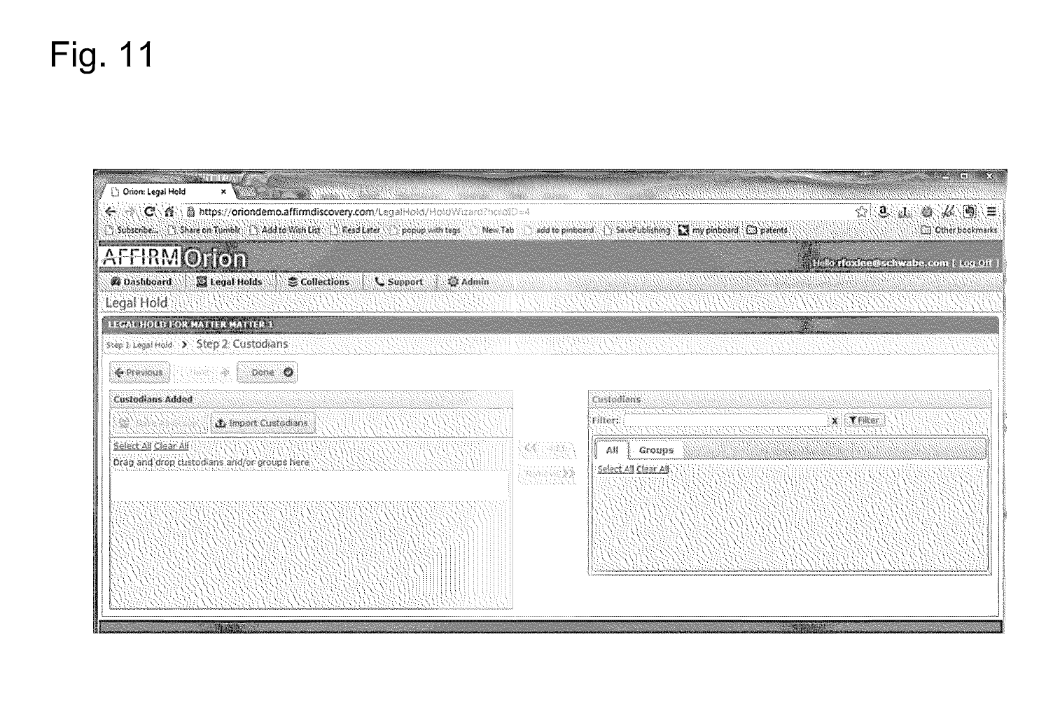

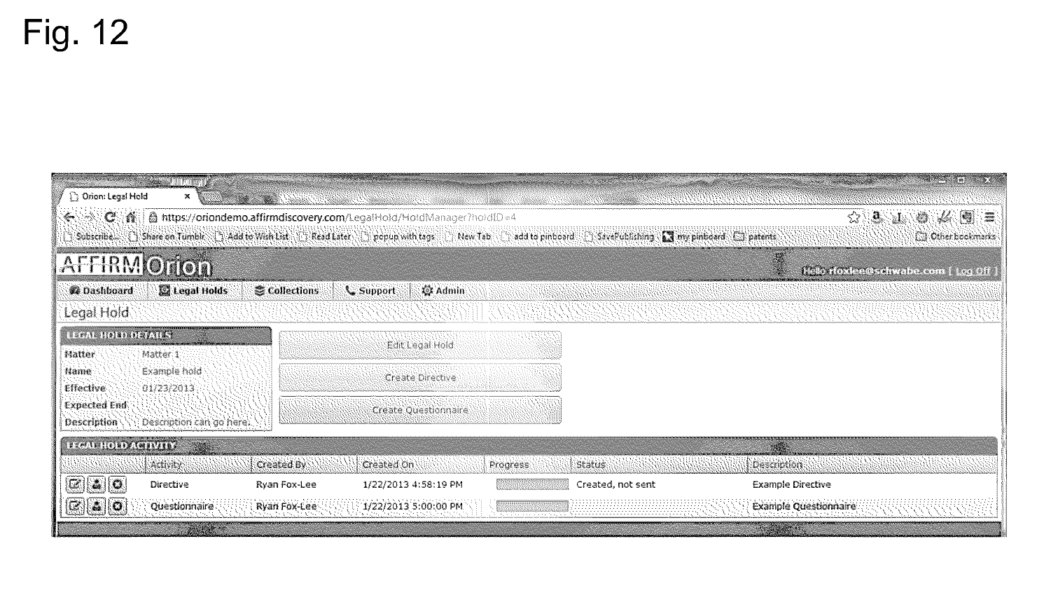

FIG. 4 is a flow diagram illustrating example processes for the EDMS facilitating and executing a legal hold. While FIG. 4 illustrates a particular order of particular operations, in various embodiments, operations of FIG. 4 may be reordered, broken into additional operations, and/or omitted entirely. The process may begin where a legal hold is configured. Particular examples of interfaces for configuring legal holds are shown in FIGS. 9-12. For example, in FIG. 9, an example interface with a listing of legal holds is shown, along with user interface elements for inspecting, deleting, and editing the legal holds. FIG. 10 shows an example interface with legal hold details, including name, effective dates, and a description. FIG. 11 shows an example interface where custodians may be added to a legal hold. In various embodiments, custodians may be added through import of a file (such as a CSV file) with custodian information, and/or through selection of groups or individuals using the interface. FIG. 12 shows an example interface where legal hold details may be viewed. As illustrated, the example interface also shows directives and/or questionnaires that have been created that are associated with the legal hold. FIG. 12 illustrates user interface elements to create directives and questionnaires, as well as to inspect, edit, and delete existing directives and questionnaires.

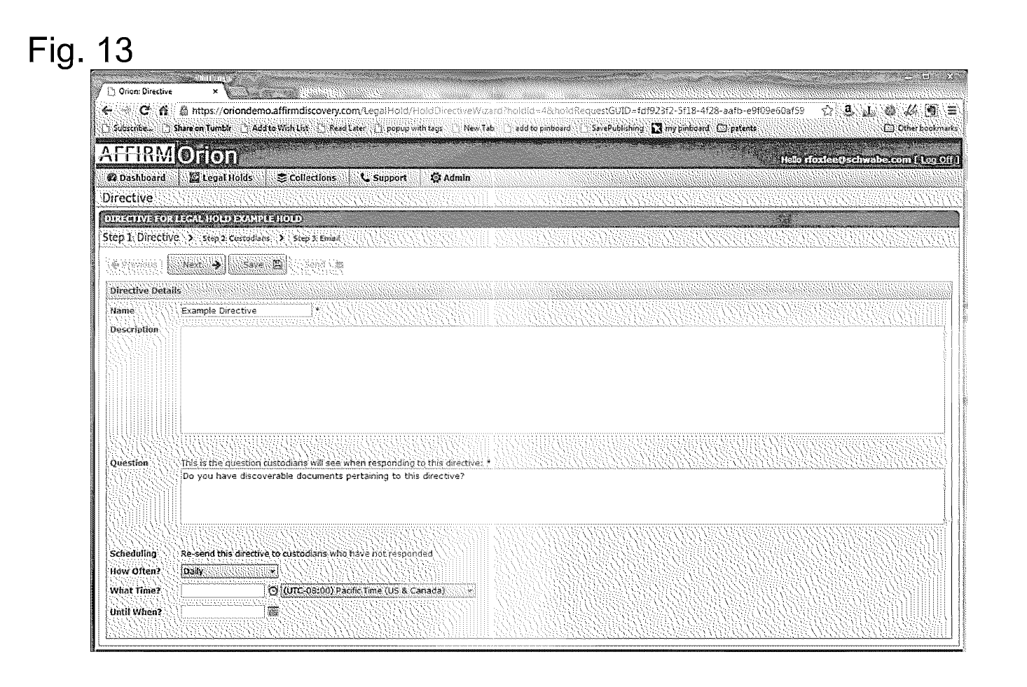

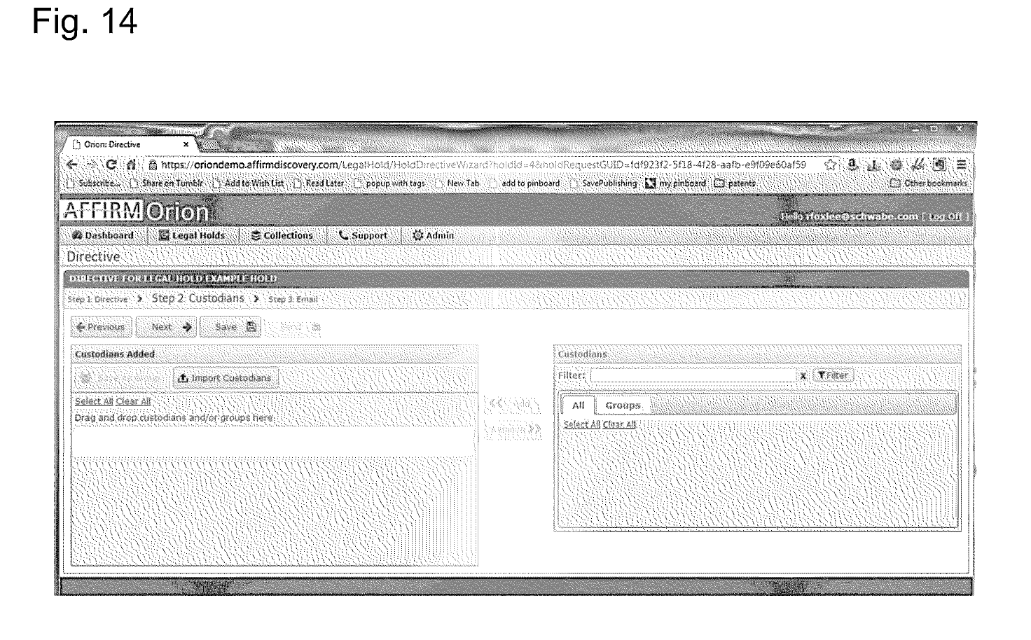

Returning to the process of FIG. 4, next a directive may be configured. Particular examples of interfaces for configuring a directive are shown in FIGS. 13 and 14. For example, in FIG. 13, an example interface is shown for configuring information about a directive, including a description and a question to be posed to custodians receiving the directive. Additionally, the interface may allow scheduling configurations such as a time to send the directive, a frequency, and an end date. FIG. 14 shows an example interface where custodians may be added to receive the directive. The example interface of FIG. 14 may provide similar functionality, in various embodiments, to the interface of FIG. 11. Returning to the process of FIG. 4, the EDMS may then facilitate the sending of the directive. In various embodiments, the EDMS may also provide an interface for emailing the directive. A similar interface is disclosed below with reference to configuration of a questionnaire.

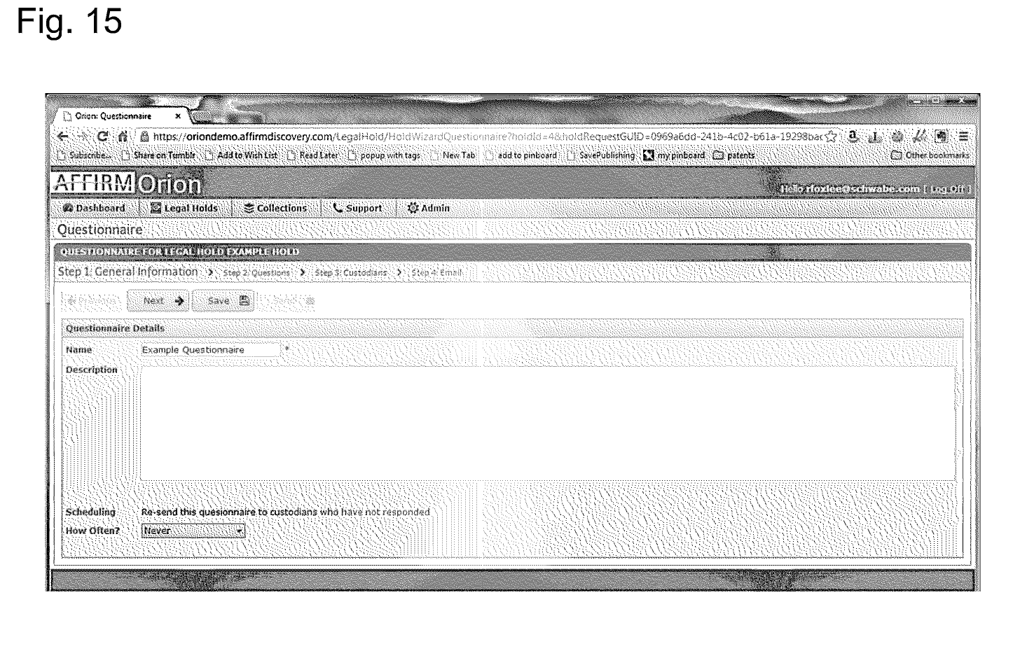

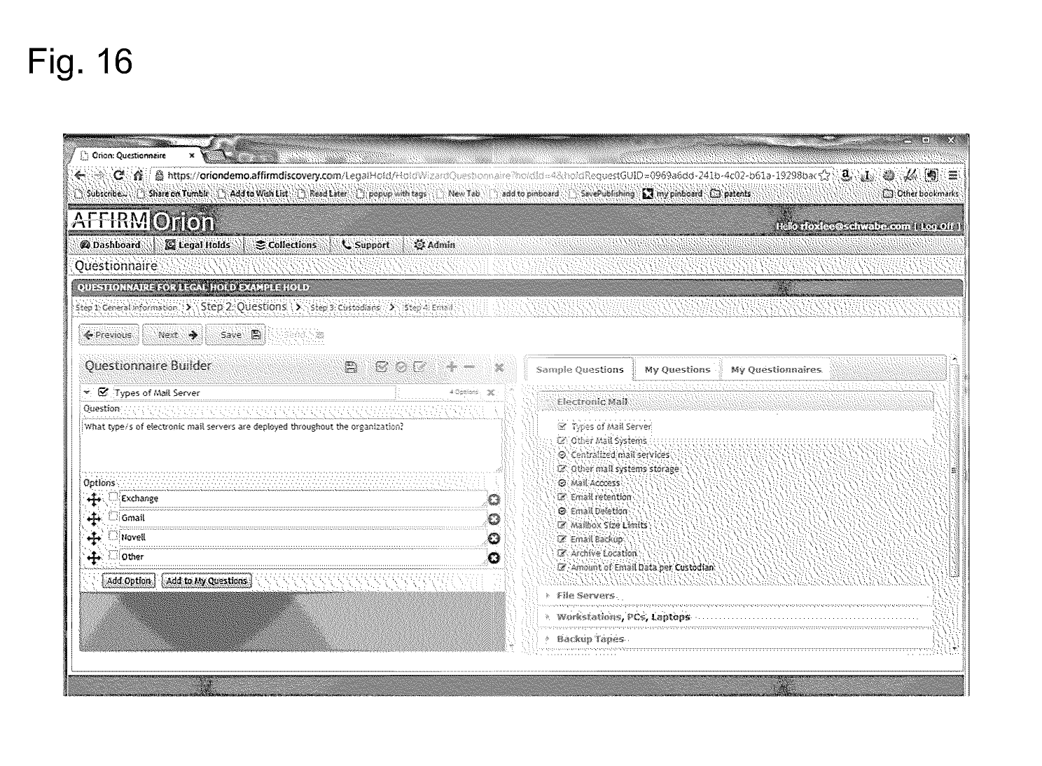

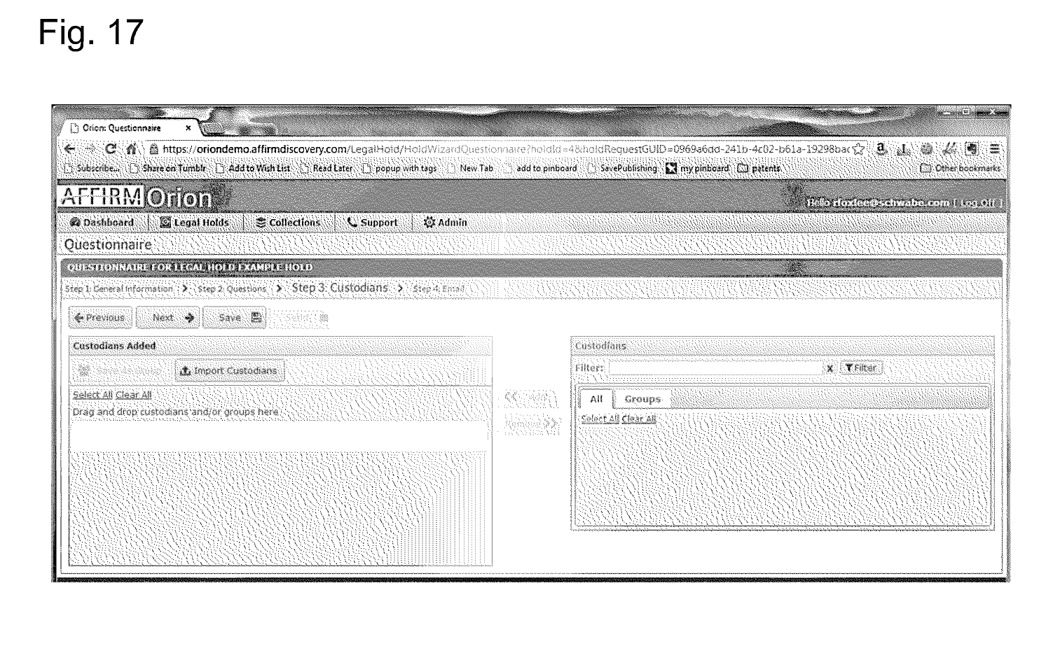

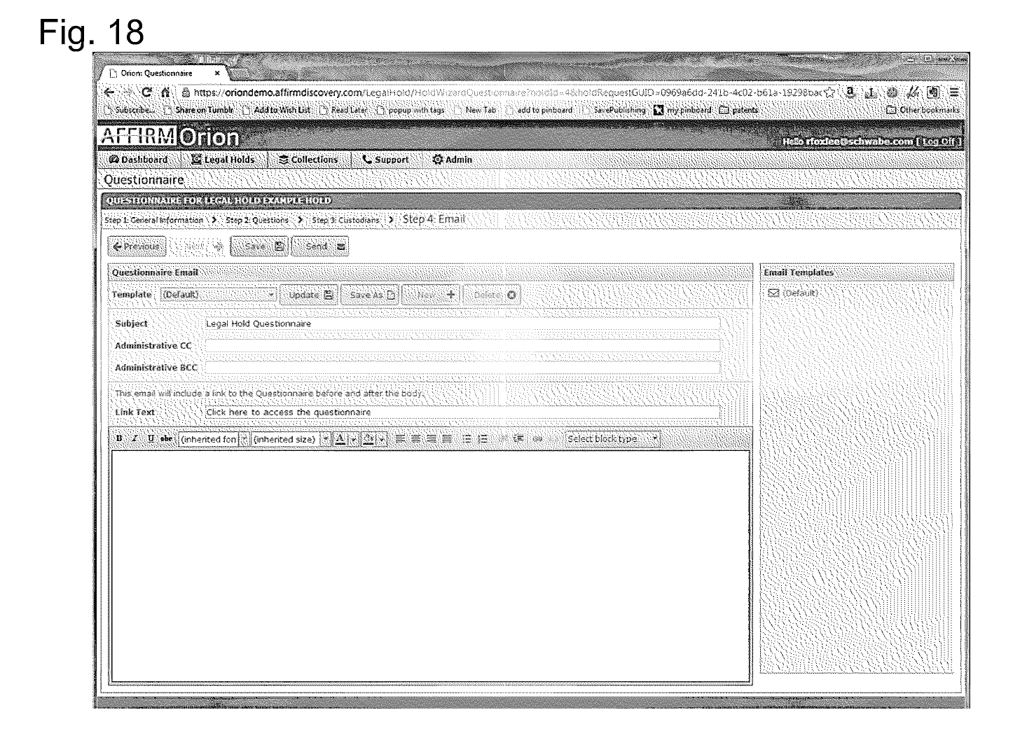

Next, in the process of FIG. 4, a questionnaire may be configured. Particular examples of interfaces for configuring a directive are shown in FIGS. 15-18. For example, in FIG. 15, an example interface is shown for configuring information about a questionnaire, including a description and scheduling configuration, such as a time to send the directive, a frequency, and an end date. FIG. 16 shows an example interface where questions may be added to the questionnaire. In various embodiments, questions may be selected from pre-formed questions, such as the one illustrated in FIG. 16. These pre-formed questions may have pre-set answers. IN various embodiments, the interface may allow for editing of the pre-formed question and/or the pre-formed answers. In various embodiments, the interface may additionally organize preformed questions into categories for easier viewing. In various embodiments, the interface may additionally allow for the creation of new questions. These questions may be saved for later use on other questionnaires. FIG. 17 shows an example interface where custodians may be added to receive the questionnaire. The example interface of FIG. 17 may provide similar functionality, in various embodiments, to other interfaces described herein. Returning to the process of FIG. 4, the EDMS may then facilitate the sending of the questionnaire. FIG. 18 shows an example interface for mailing the questionnaire. In various embodiments, the interface may provide emailing editing and review functionality for crafting the questionnaire prior to mailing. In various embodiments, mailing of the questionnaire through the mailing interface of FIG. 18 may cause the questionnaire to be sent to the previously-added custodians. The process of FIG. 4 may then end.

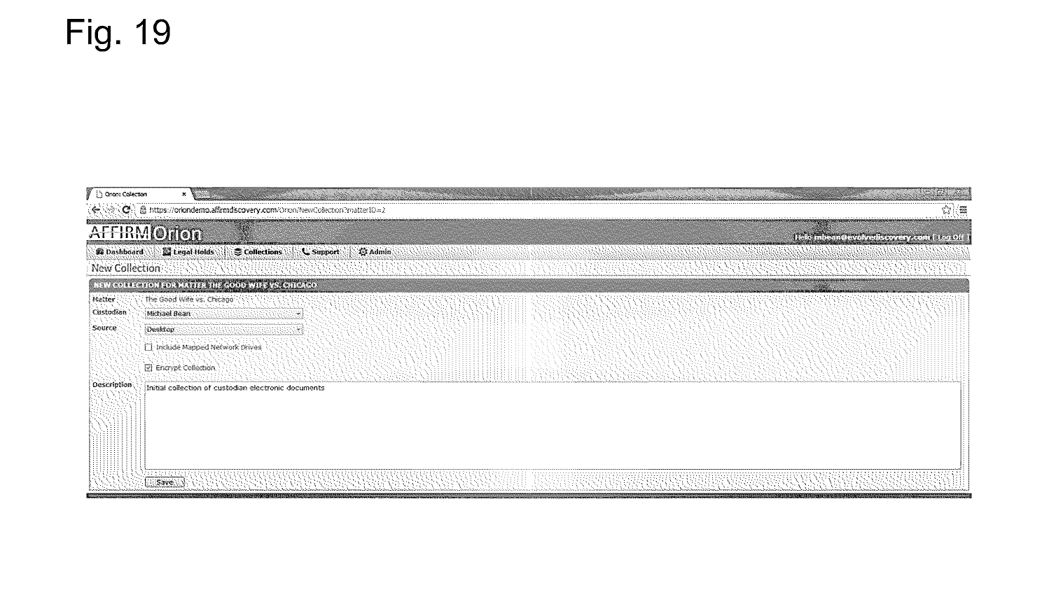

FIG. 5 is a flow diagram illustrating example processes for the EDMS facilitating and executing a collection of discoverable information. While FIG. 5 illustrates a particular order of particular operations, in various embodiments, operations of FIG. 5 may be reordered, broken into additional operations, and/or omitted entirely. The process may begin where a custodian and/or source are selected for a collection. An example interface for selecting a custodian and source is shown in FIG. 19. Additionally, a description may be created or modified for a collection in this interface.

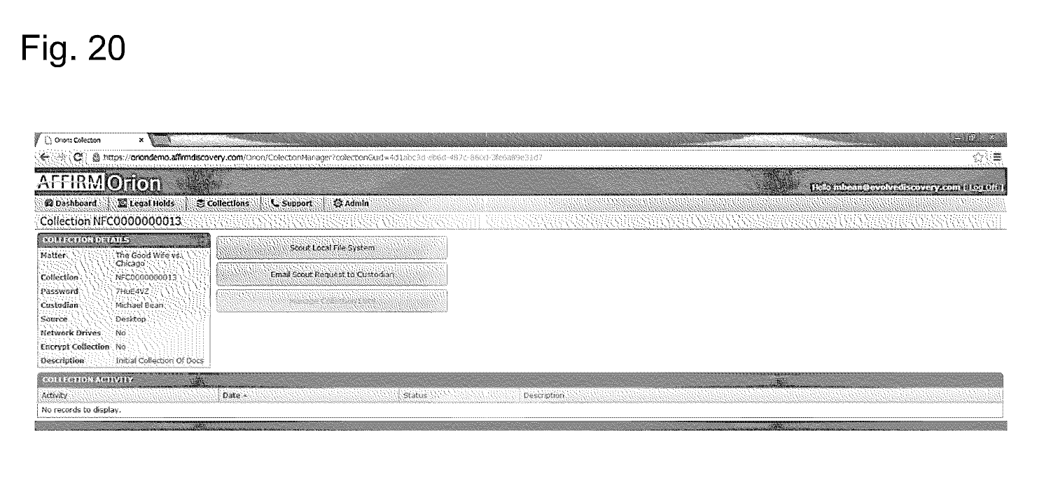

Next, the EDMS may facilitate a user in sending the scouting module to the custodian and causing the scouting module to be executed by the custodian. FIG. 20 shows an example interface describing a collection and providing user interface elements for facilitating execution of the scouting module on the custodian's computing device. In various embodiments, the EDMS may provide for local execution of the scouting module, such as by a user that has physical access to the custodian's computing device. In various embodiments, the EDMS may also provide for the ability to email a scout request to the custodian, so that the scouting module may be downloaded and executed without a requirement that the user be present at the computing device. The example interface of FIG. 20 also illustrates collection activity for the collection; in the example, no collection activity has been performed yet.

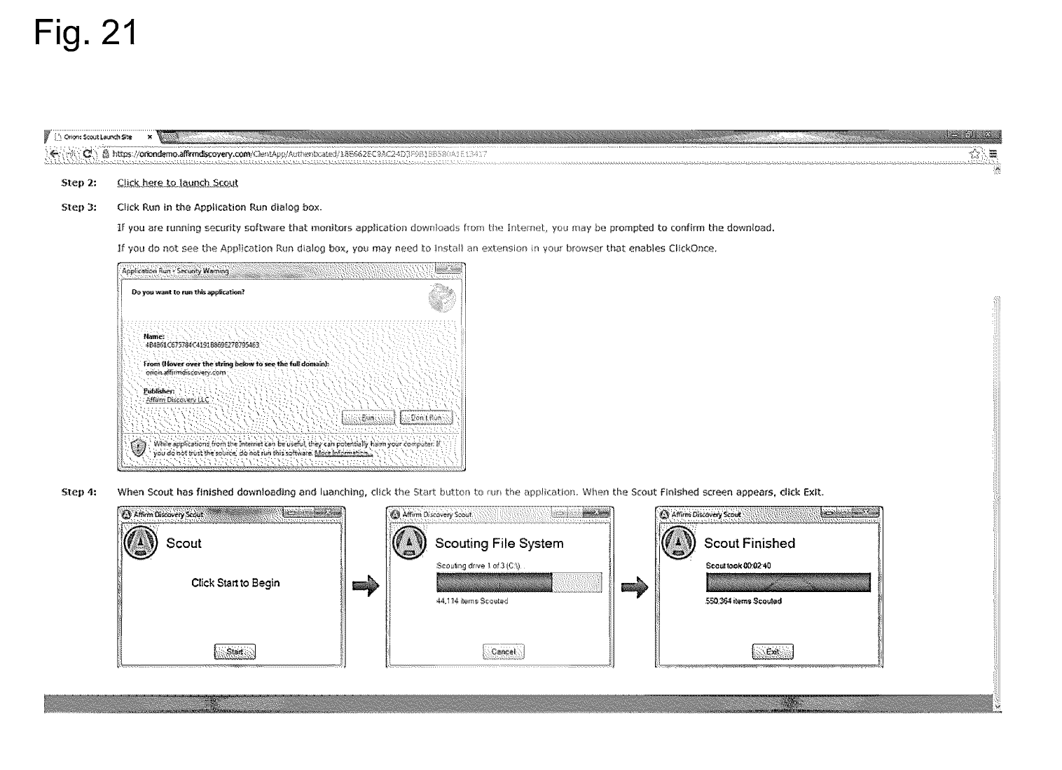

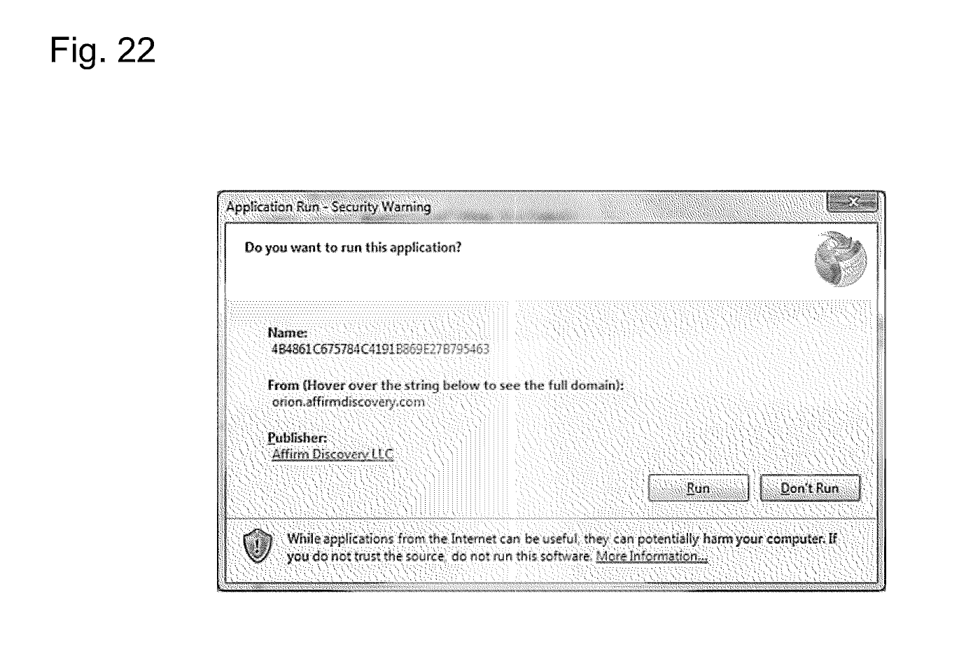

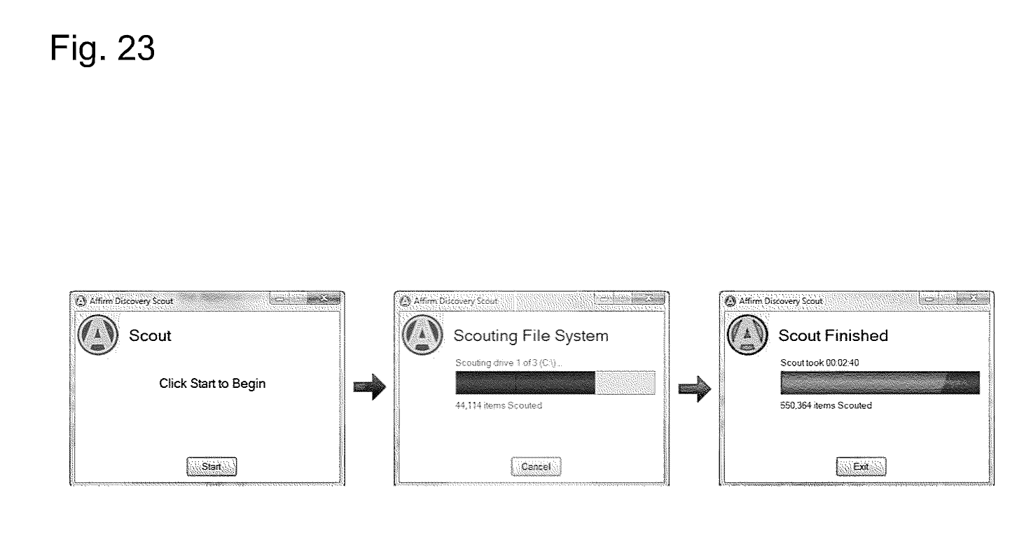

FIG. 21 shows an example interface for a custodian or for a user for executing the scouting module. In various embodiments, the interface of FIG. 21 may be visited due to selecting the local execution user interface element of FIG. 20 or by a custodian selecting a link in an emailed scout request. FIG. 22 illustrates an example dialog box asking a custodian or user whether they would allow execution of the scouting module on the custodian's computing device. FIG. 23 illustrates example process dialogs showing execution of the scouting module on the custodian's computing device.

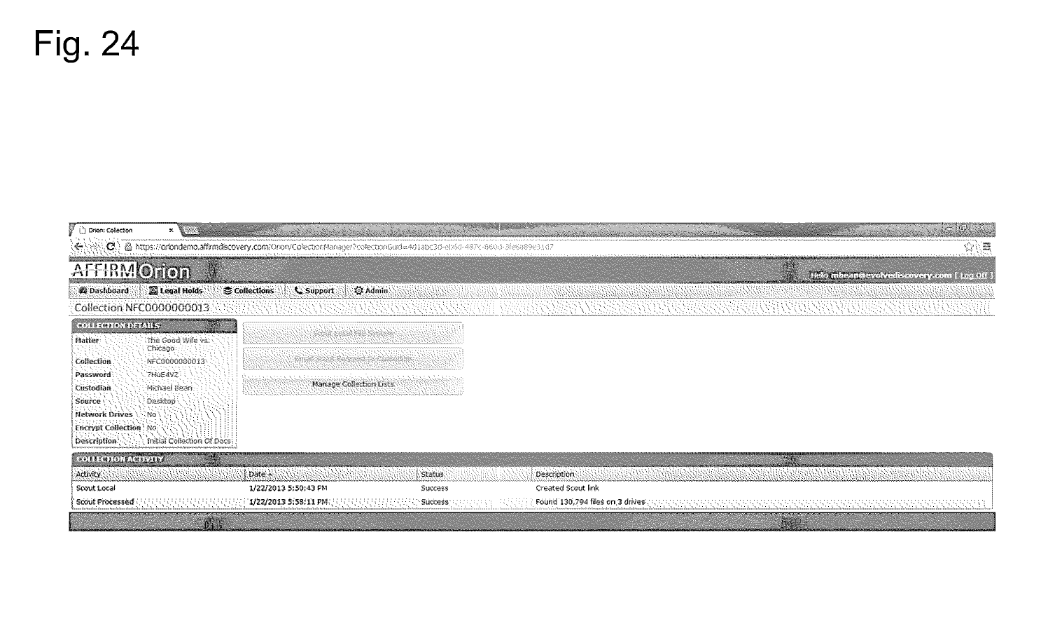

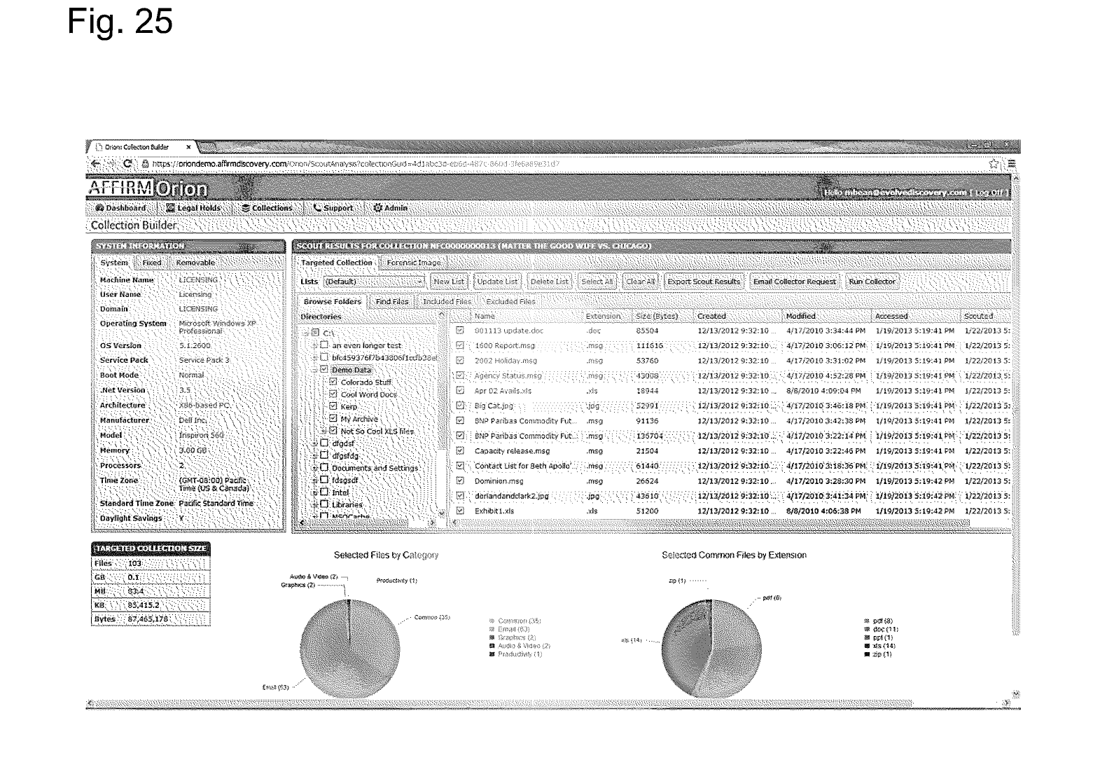

Returning to the process of FIG. 5, next the EDMS may facilitate the receipt and processing of scout results. In various embodiments, the scouting module may operate to generate information about documents and other information on sources of the custodian's computing device. In various embodiments, the results may be placed into a file and/or may be sent, such as via a network, to the EDMS. FIG. 24 shows an example interface showing collection information, similar to those above, but now showing that a scout link has been performed and the information obtained therefrom has been processed. The interface also includes a user interface element for managing collection lists. FIG. 25 shows an example interface for managing collection lists. As shown in the example, the EDMS may provide for selection of individual files and/or folders that were identified on a source of the custodian by the scouting module. In various embodiments, the EDMS may configure the collection module based at least in part on the selection of files and/or folders such that these files and/or folders are targeted for collection by the collection module. The interface of FIG. 25 also illustrates metadata about the source and selected files, such as counts by category and extension. The interface of FIG. 25 also illustrates information about the computing device of the custodian.

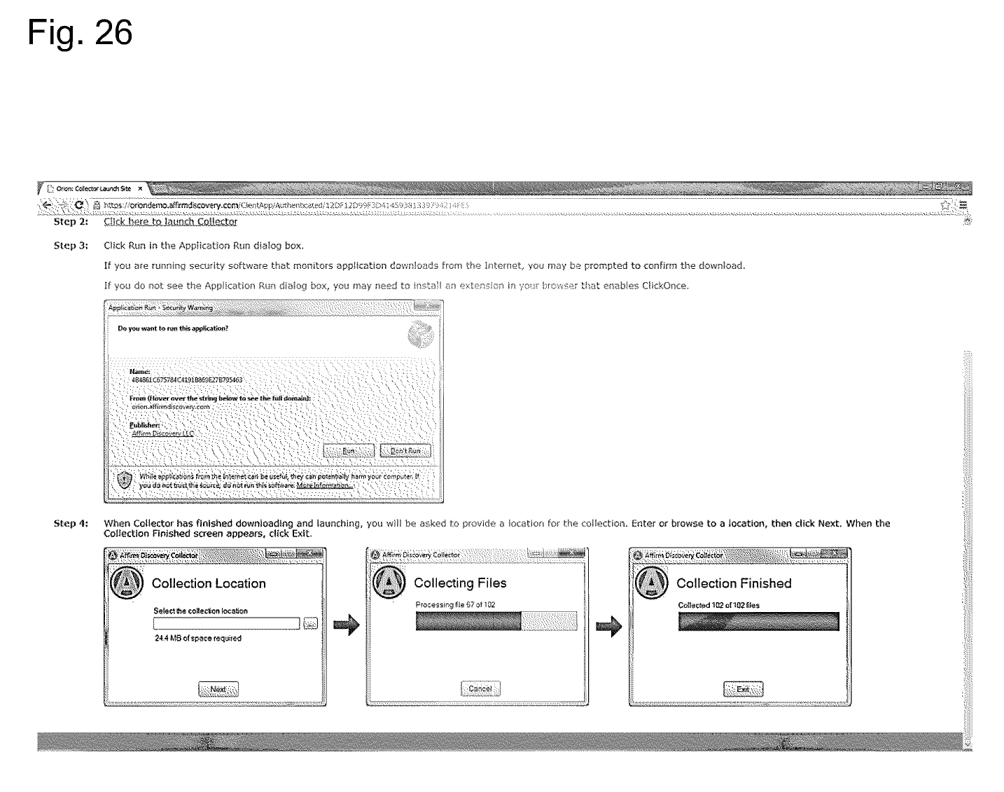

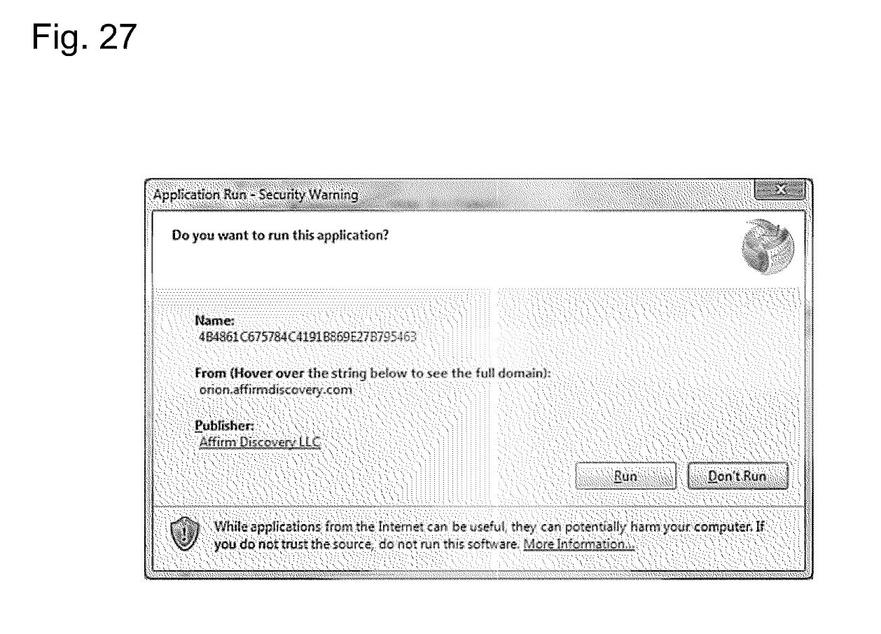

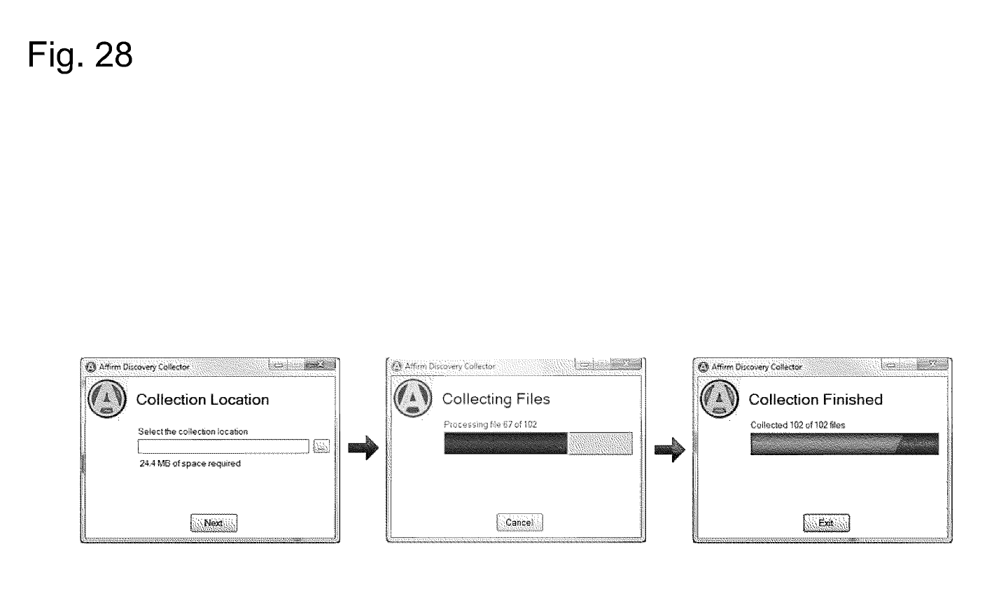

Returning to the process of FIG. 5, next the EDMS may facilitate the sending and execution of the collection module at the computing device of the custodian. In various embodiments, this operation may be begun through operation of a user interface element of the interface of FIG. 25 to “Run Collector.” In various embodiments, the collection module that is operated during this operation may be configured at least in part based on selection of files and/or folders from information obtained by the selection module. FIG. 26 shows an example interface for a custodian or for a user for executing the collection module. In various embodiments, the interface of FIG. 26 may be visited due to selecting the local execution user interface element of FIG. 25 or by a custodian selecting a link in an emailed scout request. FIG. 27 illustrates an example dialog box asking a custodian or user whether they would allow execution of the collection module on the custodian's computing device. FIG. 28 illustrates example process dialogs showing execution of the collection module on the custodian's computing device.

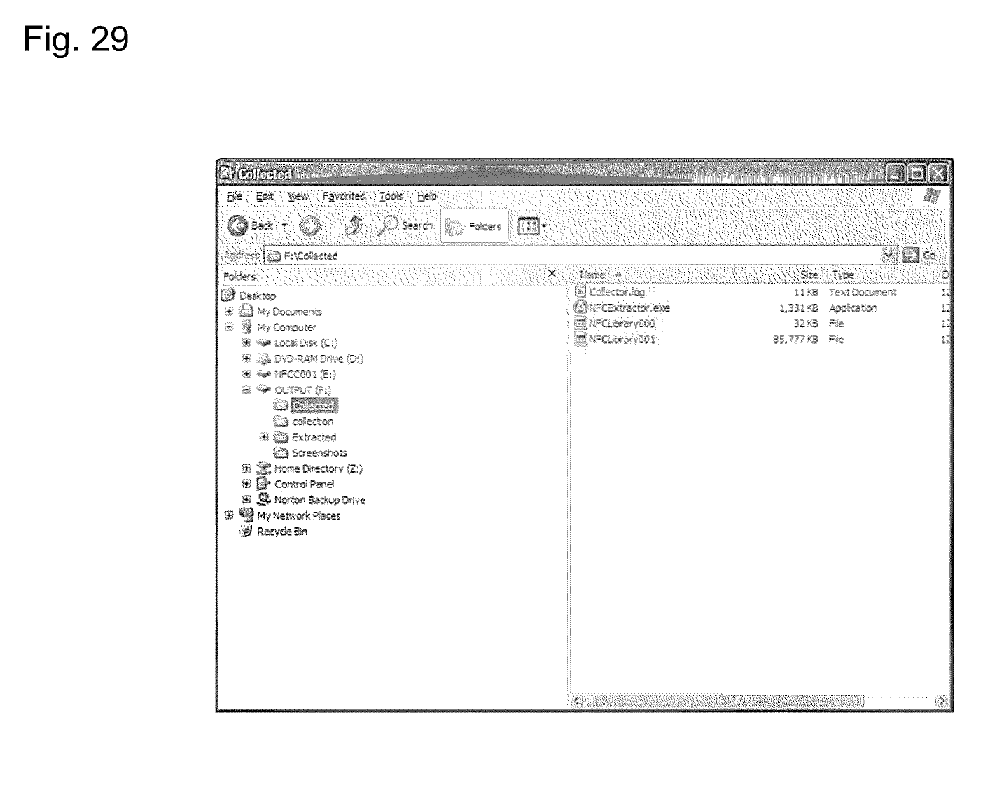

FIG. 29 illustrates an example save dialog for a user or custodian to save collected information locally to the custodian's computing device. In various embodiments, the collected information may be saved as a single file or as multiple files. In various embodiments, the collected information may be encrypted; the encryption key may be set, in various embodiments, by the user of the EDMS. In various embodiments, the saved collected information may be sent to the EDMS, such as through a network. In other embodiments, the collection module may be configured to upload collected information (in encrypted or unencrypted form) directly to the EDMS.

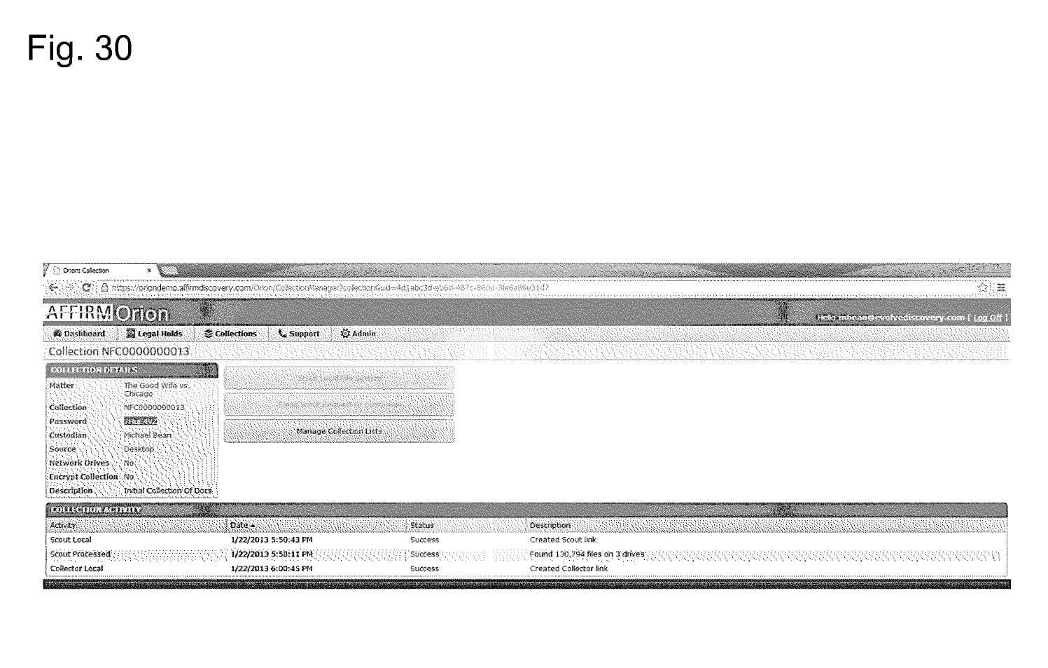

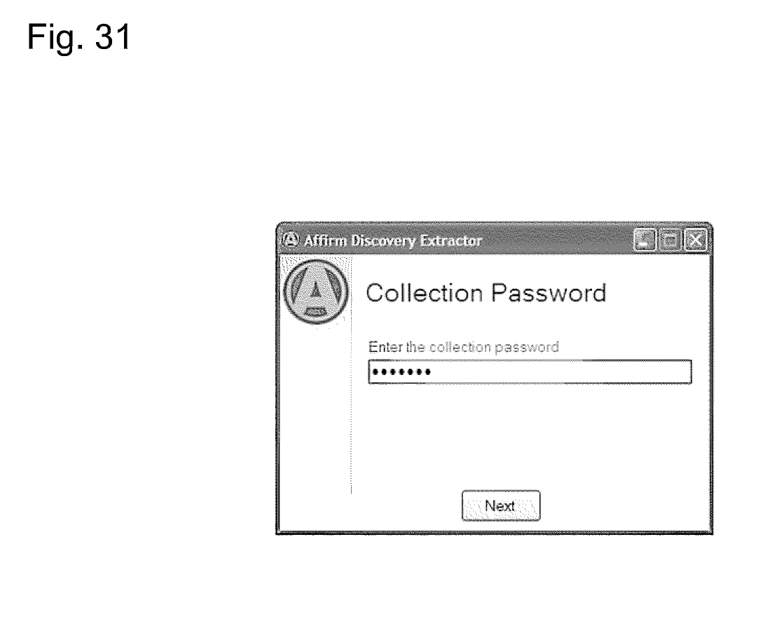

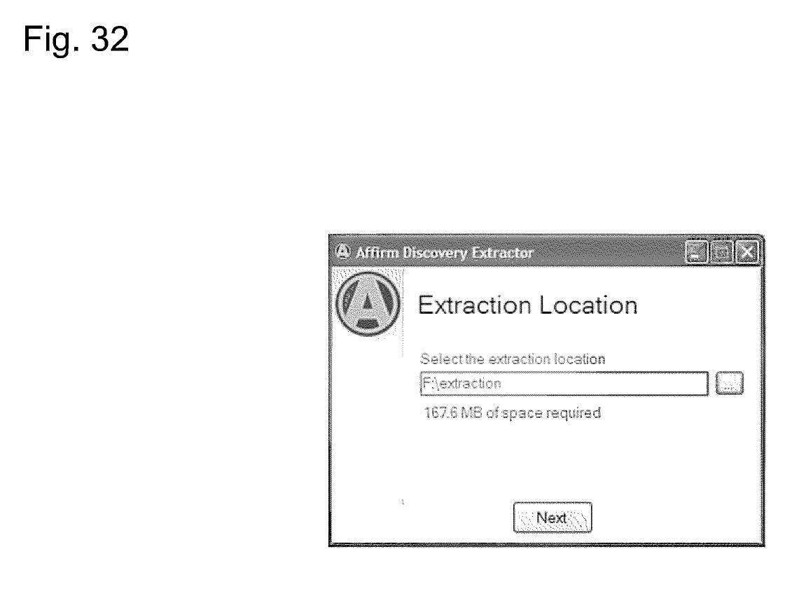

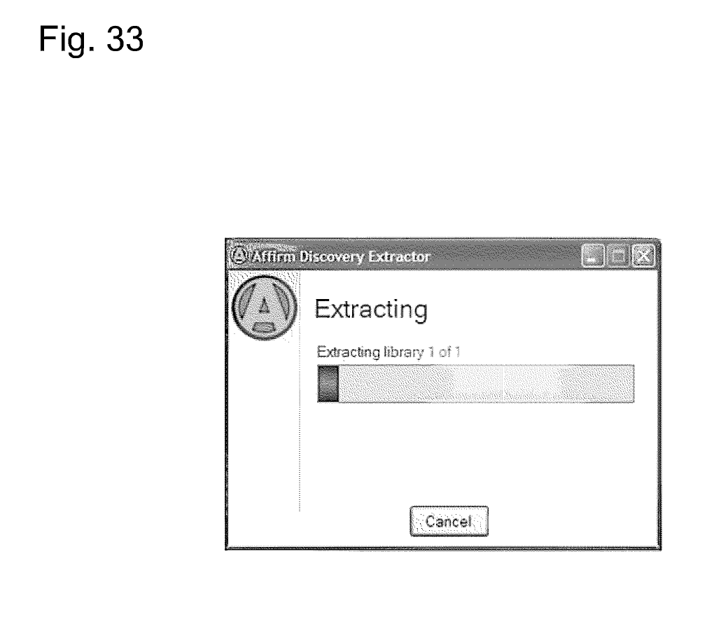

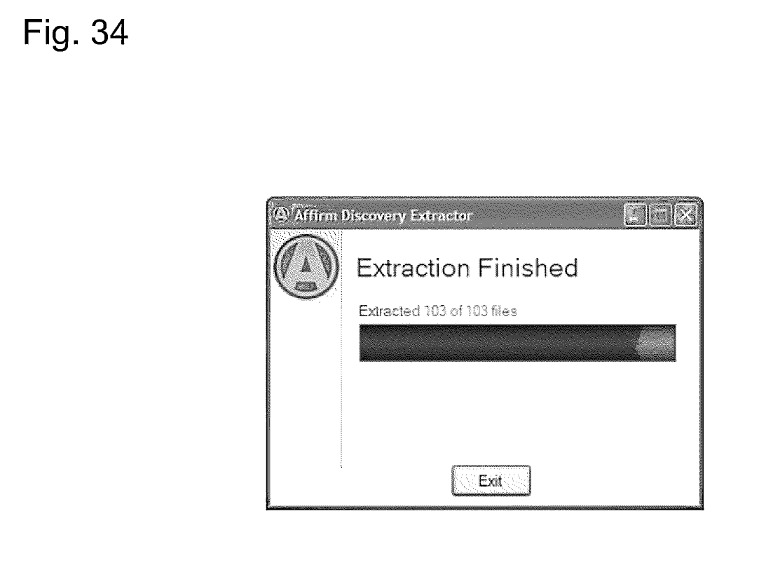

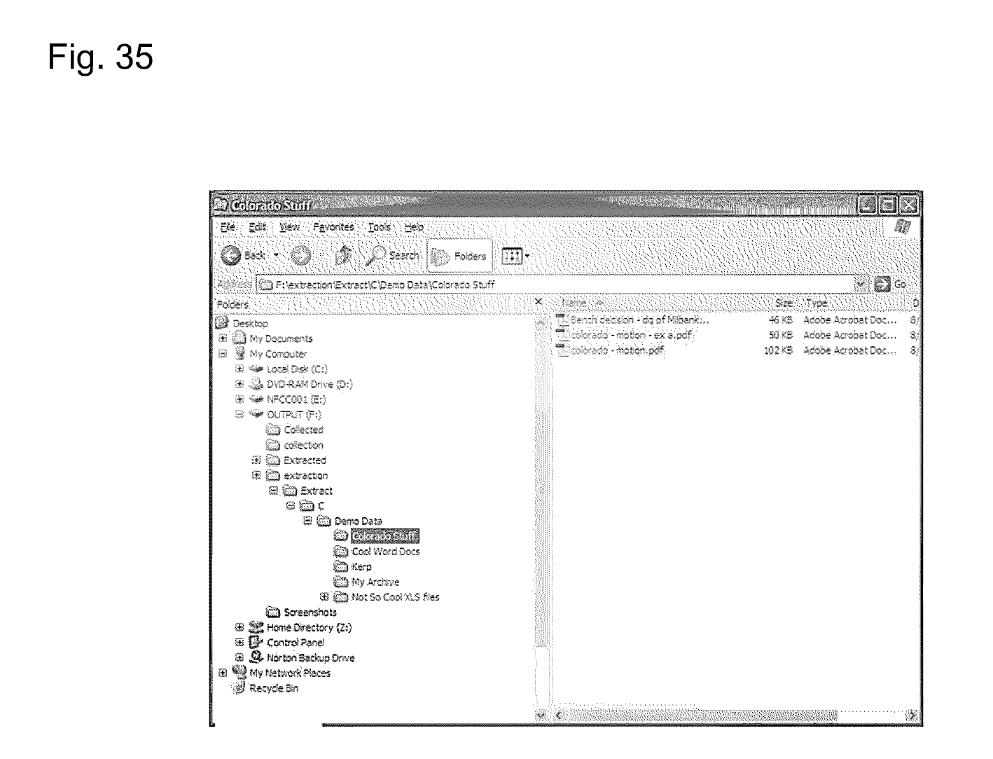

Returning to FIG. 5, next the EDMS may receive the collected information. FIG. 30 shows an example interface of the EDMS showing that the collected information has been received. Next, the EDMS may extract the collection results. FIG. 31 shows an example dialog box for a user entering an encryption password to view the collected information. FIG. 32 shows an example dialog box for the user to select a location for saving the extracted collected information after decryption. FIGS. 33 and 34 show example progress dialog boxes that show extraction progress. FIG. 35 shows an example interface of a computing device to which the extracted collected information has been saved. In various embodiments, and as illustrated, the collected information may be saved using a file structure identical to or similar to that on the custodian's source from which it was taken. The process of FIG. 5 may then end.

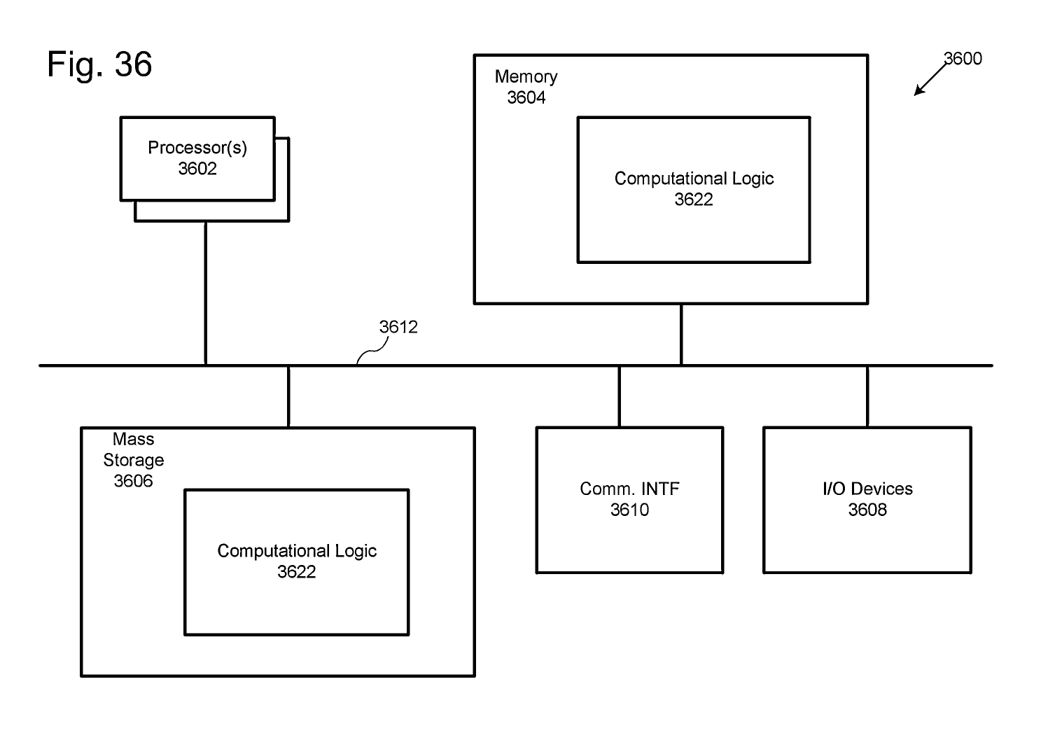

Referring now to FIG. 36, an example computer suitable for use in accordance with various embodiments, is illustrated. As shown, computer 3600 may include one or more processors or processor cores 3602, and system memory 3604. For the purpose of this application, including the claims, the terms “processor” and “processor cores” may be considered synonymous, unless the context clearly requires otherwise. Additionally, computer 3600 may include mass storage devices 3606 (such as diskette, hard drive, compact disc read only memory (CD-ROM) and so forth), input/output devices 3608 (such as display, keyboard, cursor control and so forth) and communication interfaces 3610 (such as network interface cards, modems and so forth). The elements may be coupled to each other via system bus 3612, which may represent one or more buses. In the case of multiple buses, they may be bridged by one or more bus bridges (not shown).

Each of these elements may perform its conventional functions known in the art. In particular, system memory 3604 and mass storage devices 3606 may be employed to store a working copy and a permanent copy of the programming instructions implementing the operations described herein. The various elements may be implemented by assembler instructions supported by processor(s) 3602 or high-level languages, such as, for example, C, that can be compiled into such instructions.

The permanent copy of the programming instructions may be placed into permanent storage devices 3606 in the factory, or in the field, through, for example, a distribution medium (not shown), such as a compact disc (CD), or through communication interface 3610 (from a distribution server (not shown)). That is, one or more distribution media having an implementation of the agent program may be employed to distribute the agent and program various computing devices.

The number, capability and/or capacity of these elements 3610-3612 may vary, depending on how computer 3600 is used. Their constitutions are otherwise known, and accordingly will not be further described.

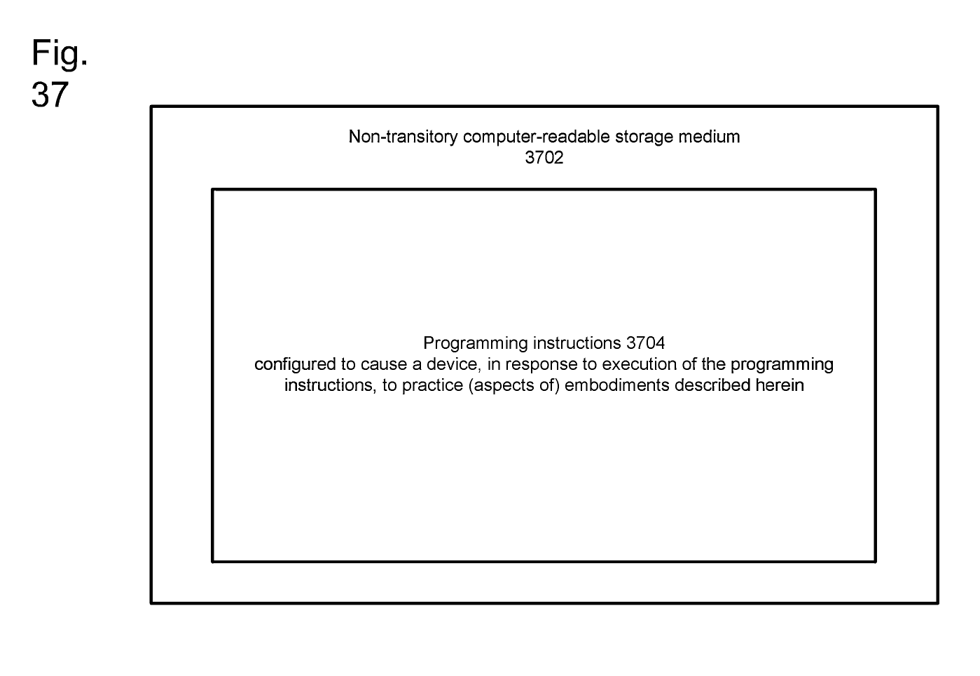

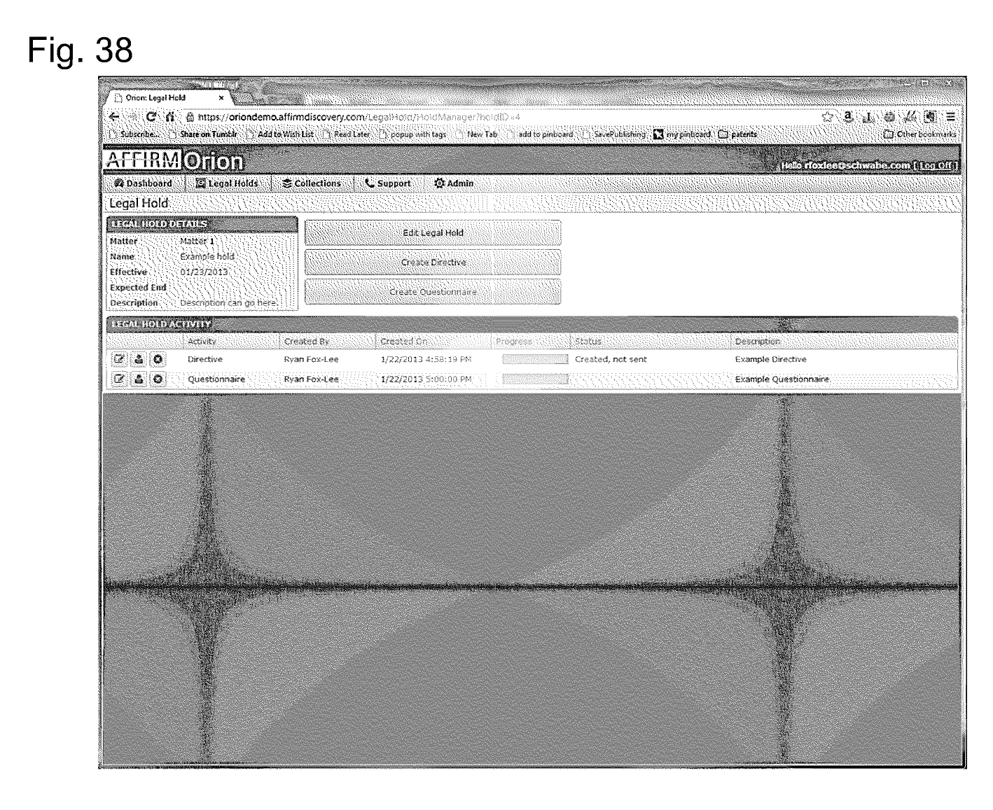

FIG. 37 illustrates an example non-transitory computer-readable storage medium having instructions configured to practice all or selected ones of the operations described herein accordance with various embodiments. As illustrated, non-transitory computer-readable storage medium 3702 may include a number of programming instructions 3704. Programming instructions 3704 may be configured to enable a device, e.g., computer 3600, in response to execution of the programming instructions, to perform, e.g., various operations of processes of FIGS. 2-5. In alternate embodiments, programming instructions 3704 may be disposed on multiple non-transitory computer-readable storage media 3702 instead.

Referring back to FIG. 36, for one embodiment, at least one of processors 3602 may be packaged together with computational logic 3622 configured to practice aspects of processes of FIGS. 2-5. For one embodiment, at least one of processors 3602 may be packaged together with computational logic 3622 configured to practice aspects of processes of FIGS. 2-5 to form a System in Package (SiP). For one embodiment, at least one of processors 3602 may be integrated on the same die with computational logic 3622 configured to practice aspects of processes of FIGS. 2-5. For one embodiment, at least one of processors 3602 may be packaged together with computational logic 3622 configured to practice aspects of processes of FIG. 25 to form a System on Chip (SoC). For at least one embodiment, the SoC may be utilized in, e.g., but not limited to, a computing tablet.

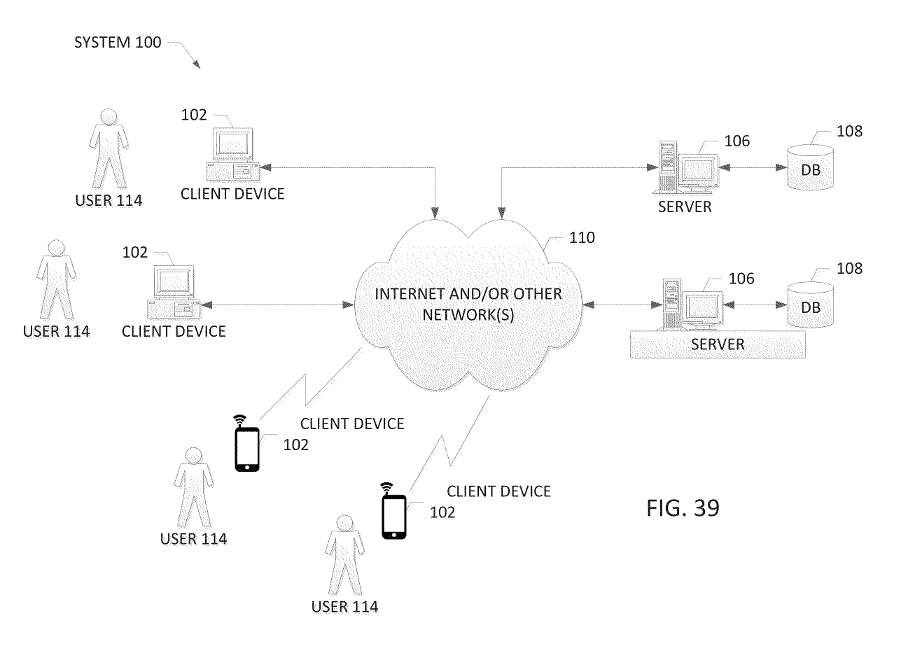

A block diagram of certain elements of an example network communication system 100 is illustrated in FIG. 39. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network. In addition, for ease in explanation, this description may refer to a client device 102 and a server 106 communicating (e.g., an interactive website). It will be appreciated that any number of client devices 102 and servers 106 may be used in the same manner as the simplified one-to-one examples used herein.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

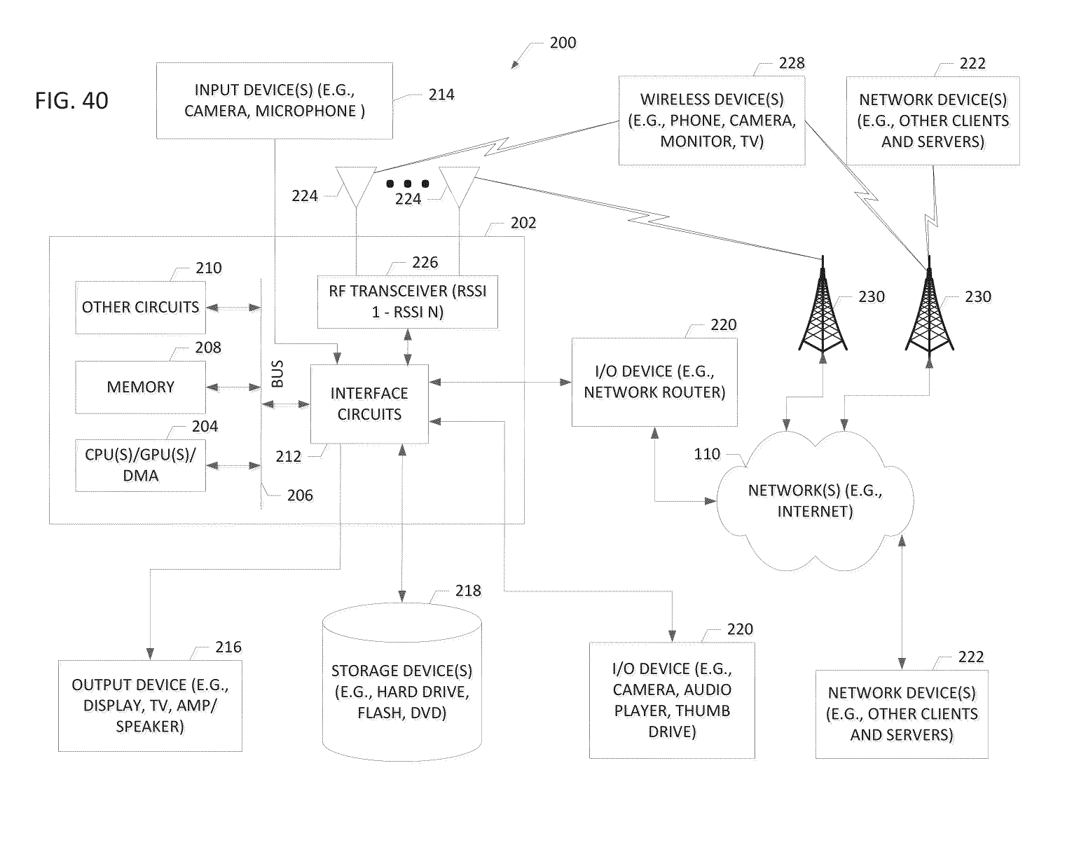

Each of the devices illustrated in FIG. 39 (e.g., client 102 and/or server 106) may include certain common aspects of many computing devices such as microprocessors, memories, direct memory access units, peripherals, etc. FIG. 40 is a block diagram of an example computing device.

The example computing device 200 includes a main unit 202 which may include, if desired, one or more processing units 204 electrically coupled by an address/data bus 206 to one or more memories 208, other computer circuitry 210, and one or more interface circuits 212. The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, isopoint, camera, voice recognition system, accelerometer, global positioning system (GPS), and/or any other suitable input device.

One or more displays, printers, speakers, monitors, televisions, high definition televisions, and/or other suitable output devices 216 may also be connected to the main unit 202 via the interface circuit 212. For example, a display for displaying video data may be a cathode ray tube (CRTs), liquid crystal displays (LCDs), electronic ink (e-ink), and/or any other suitable type of display.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200.

The computing device 200 may also exchange data with one or more input/output (I/O) devices 220. For example, I/O devices 220 may include network routers, cameras, audio players, thumb drives etc.

The computing device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 (e.g., customers and contractors) of the system 100 may be required to register with a server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

In some embodiments, the computing device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a Bluetooth transceiver, a Wi-Fi transceiver, and/or diversity cellular transceivers. The transceiver(s) 226 allow the device 200 to exchange signals, such as voice, video and any other suitable data, with other wireless devices 228, such as a phone, camera, monitor, television, and/or high definition television. For example, the device 200 may send and receive wireless telephone signals, text messages, audio signals and/or video signals directly and/or via a base station 230.

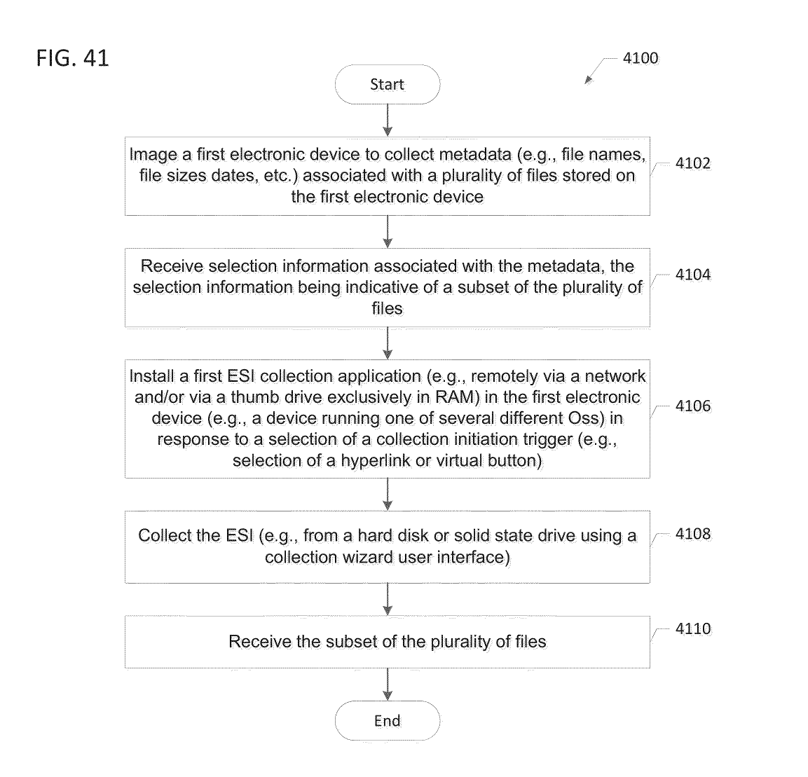

A flowchart of an example process 4100 for collecting electronically stored information is illustrated in FIG. 41. The process 4100 may be carried out by one or more suitably programmed processors, such as a CPU executing software (e.g., block 204 of FIG. 2). The process 4100 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 4100 is described with reference to the flowchart illustrated in FIG. 41, it will be appreciated that many other methods of performing the acts associated with process 4100 may be used. For example, the order of many of the operations may be changed, and some of the operations described may be optional.

More specifically, in this example, the process 4100 begins when a processor images a first electronic device to collect metadata associated with a plurality of files stored on the first electronic device (block 4102). For example, the metadata may include file names, file sizes dates, etc. The processor then receives selection information associated with the metadata, the selection information being indicative of a subset of the plurality of files (block 4104). The processor then installs a first ESI collection application (e.g., remotely via a network and/or via a thumb drive exclusively in RAM) in the first electronic device (e.g., a device running one of several different Oss) in response to a selection of a collection initiation trigger (e.g., selection of a hyperlink or virtual button) (block 4106). The processor then collects the ESI (block 4108). For example, the processor may collect the ESI from a hard disk or solid state drive using a collection wizard user interface. The processor then receives the subset of the plurality of files (block 4110).

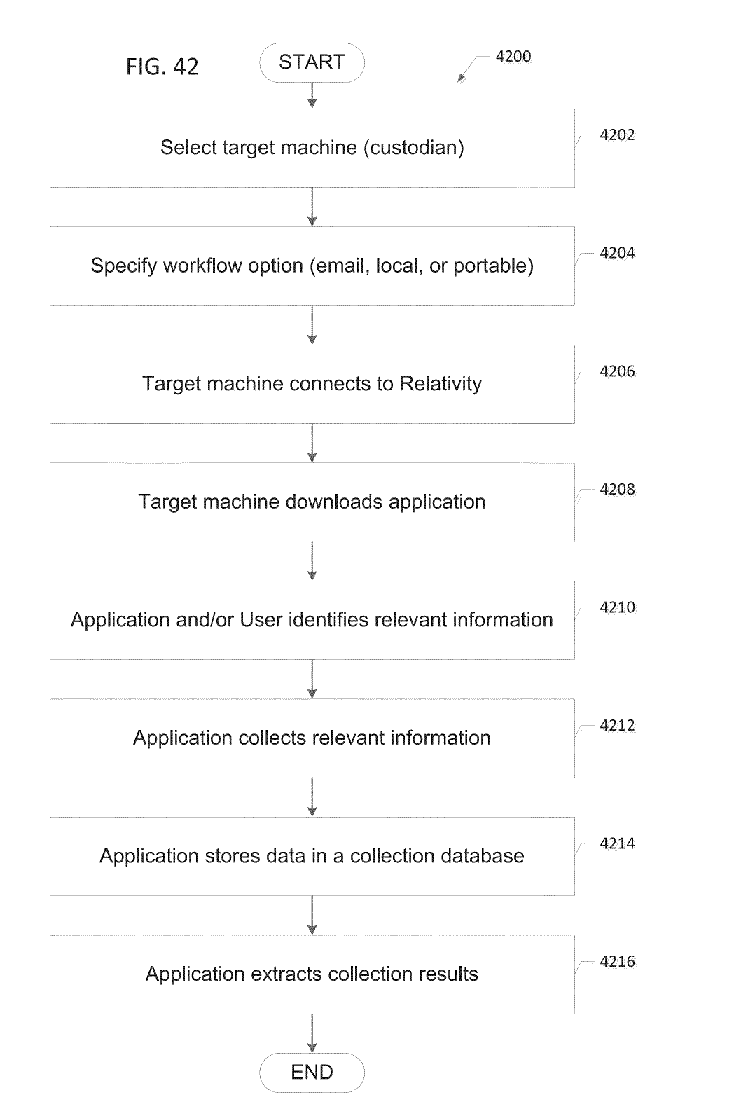

A flowchart of an example scout process 4200 is illustrated in FIG. 42. The process 4200 may be carried out by one or more suitably programmed processors, such as a CPU executing software (e.g., block 204 of FIG. 2). The process 4200 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 4200 is described with reference to the flowchart illustrated in FIG. 42, it will be appreciated that many other methods of performing the acts associated with process 4200 may be used. For example, the order of many of the operations may be changed, and some of the operations described may be optional.

More specifically, in this example, the process 4200 begins when a processor selects a target custodian machine (block 4202). The processor or a user then specifies a workflow option, such as email, local, and/or portable (block 4204). The target machine then connects to Relativity or other suitable application (block 4206). The target machine then downloads the scout application (block 4208). The application and/or user then identifies relevant information (block 4210). The processor then application then collects the relevant information (block 4212). The application then stores the data in a collection database (block 4214). The application then extracts the collection results (block 4204).

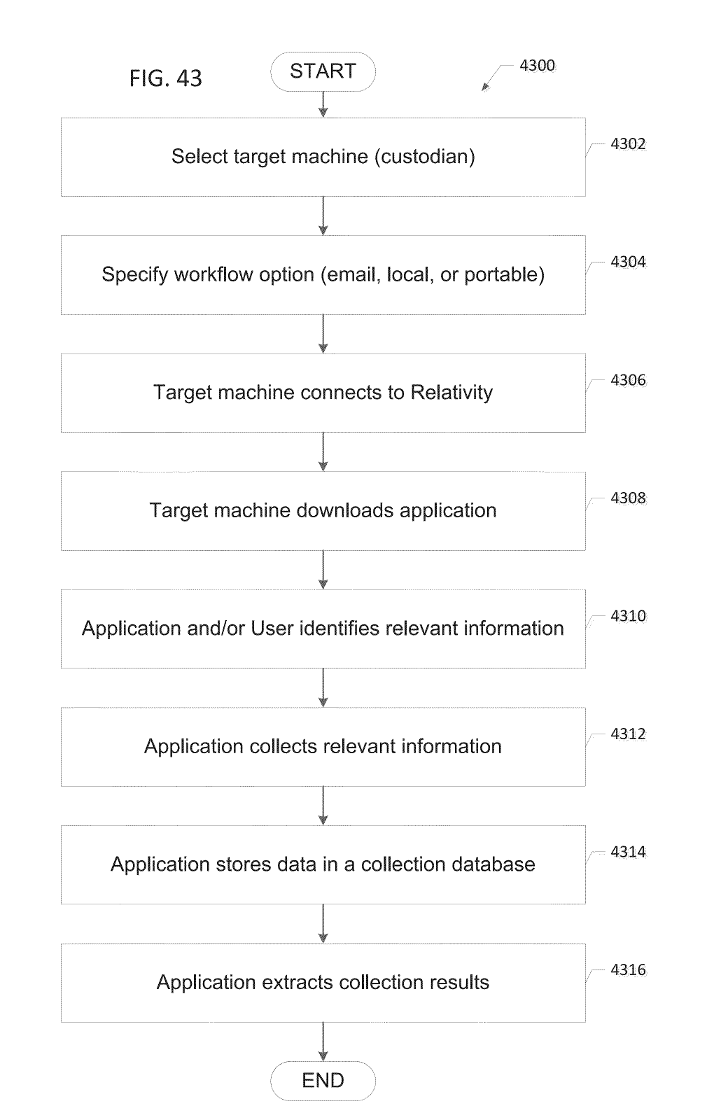

A flowchart of an example collection process 4300 is illustrated in FIG. 43. The process 4300 may be carried out by one or more suitably programmed processors, such as a CPU executing software (e.g., block 204 of FIG. 2). The process 4300 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 4300 is described with reference to the flowchart illustrated in FIG. 43, it will be appreciated that many other methods of performing the acts associated with process 4300 may be used. For example, the order of many of the operations may be changed, and some of the operations described may be optional.

More specifically, in this example, the process 4300 begins when a processor selects a target custodian machine (block 4302). The processor or a user then specifies a workflow option, such as email, local, or portable (block 4304). The target machine then connects to relativity or other suitable application (block 4306). The target machine then downloads the collection application (block 4308). Application and/or User identifies relevant information (block 4310). The application then collects the relevant information (block 4312). Application stores data in a collection database (block 434). Application extracts collection results (block 4316).

In summary, persons of ordinary skill in the art will readily appreciate that methods and apparatus for collecting electronically stored information have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of collecting electronically stored information (ESI), the method comprising:
imaging a first electronic device to collect metadata associated with a plurality of files stored on the first electronic device;
receiving selection information associated with the metadata, the selection information being indicative of a subset of the plurality of files;
installing a first ESI collection application in the first electronic device in response to a selection of a collection initiation trigger; and
receiving the subset of the plurality of files.

2. The method of claim 1, further comprising transmitting an ESI collection request message to the first electronic device, the ESI collection request message including the collection initiation trigger.

3. The method of claim 2, wherein the collection initiation trigger includes a hyperlink.

4. The method of claim 2, wherein the collection initiation trigger includes a virtual button.

5. The method of claim 1, wherein installing the first ESI collection application includes installing the first ESI collection application remotely via a network.

6. The method of claim 1, wherein installing the first ESI collection application includes installing the first ESI collection application exclusively in a first random access memory of the first electronic device.

7. The method of claim 6, wherein the second ESI collection application is installed from a thumb drive.

8. The method of claim 1, further comprising installing a second ESI collection application in a second different electronic device, wherein the first electronic device executes a first operating system and the second electronic device executes a second different operating system.

9. The method of claim 8, wherein the first ESI collection application collects ESI from a solid state drive and the second ESI collection application collects ESI from a hard disk drive.

10. The method of claim 8, wherein the first ESI collection application collects ESI from a hard disk drive and the second ESI collection application collects ESI from a solid state drive.

11. The method of claim 1, wherein executing the first ESI collection application includes displaying an ESI collection wizard.

12. The method of claim 11, wherein executing a second ESI collection application includes displaying the ESI collection wizard.

13. An apparatus for collecting electronically stored information (ESI), the apparatus comprising:
a processor;
a network interface operatively coupled to the processor; and
a memory device operatively coupled to the processor, the memory device storing instructions structured to cause the processor to:
image a first electronic device to collect metadata associated with a plurality of files stored on the first electronic device;
receive selection information associated with the metadata, the selection information being indicative of a subset of the plurality of files;
install a first ESI collection application in the first electronic device in response to a selection of a collection initiation trigger; and
receive the subset of the plurality of files.

14. The apparatus of claim 13, wherein the instructions are structured to cause the processor to transmit an ESI collection request message to the first electronic device via the network interface, the ESI collection request message including the collection initiation trigger.

15. The apparatus of claim 14, wherein the collection initiation trigger includes a hyperlink.

16. The apparatus of claim 14, wherein the collection initiation trigger includes a virtual button.

17. The apparatus of claim 13, wherein installing the first ESI collection application includes installing the first ESI collection application remotely via the network interface.

18. The apparatus of claim 13, wherein installing the first ESI collection application includes installing the first ESI collection application exclusively in a first random access memory of the first electronic device.

19. The apparatus of claim 18, wherein the second ESI collection application is installed from a thumb drive.

20. The apparatus of claim 13, wherein the instructions are structured to cause the processor to install a second ESI collection application in a second different electronic device, wherein the first electronic device executes a first operating system and the second electronic device executes a second different operating system.

21. The apparatus of claim 20, wherein the first ESI collection application collects ESI from a solid state drive and the second ESI collection application collects ESI from a hard disk drive.

22. The apparatus of claim 20, wherein the first ESI collection application collects ESI from a hard disk drive and the second ESI collection application collects ESI from a solid state drive.

23. The apparatus of claim 13, wherein executing the first ESI collection application includes displaying an ESI collection wizard.

24. The apparatus of claim 23, wherein executing a second ESI collection application includes displaying the ESI collection wizard.

25. A non-transitory memory device storing instructions structure to cause a processor to:
image a first electronic device to collect metadata associated with a plurality of files stored on the first electronic device;
receive selection information associated with the metadata, the selection information being indicative of a subset of the plurality of files;
install a first ESI collection application in the first electronic device in response to a selection of a collection initiation trigger; and
receive the subset of the plurality of files.

26. The memory device of claim 25, wherein the instructions are structured to cause the processor to transmit an ESI collection request message to the first electronic device via the network interface, the ESI collection request message including the collection initiation trigger.

27. The memory device of claim 26, wherein the collection initiation trigger includes a hyperlink.

28. The memory device of claim 26, wherein the collection initiation trigger includes a virtual button.

29. The memory device of claim 25, wherein installing the first ESI collection application includes installing the first ESI collection application remotely via the network interface.

30. The memory device of claim 25, wherein installing the first ESI collection application includes installing the first ESI collection application exclusively in a first random access memory of the first electronic device.

31. The memory device of claim 30, wherein the second ESI collection application is installed from a thumb drive.

32. The memory device of claim 25, wherein the instructions are structured to cause the processor to install a second ESI collection application in a second different electronic device, wherein the first electronic device executes a first operating system and the second electronic device executes a second different operating system.

33. The memory device of claim 32, wherein the first ESI collection application collects ESI from a solid state drive and the second ESI collection application collects ESI from a hard disk drive.

34. The memory device of claim 32, wherein the first ESI collection application collects ESI from a hard disk drive and the second ESI collection application collects ESI from a solid state drive.

35. The memory device of claim 25, wherein executing the first ESI collection application includes displaying an ESI collection wizard.

36. The memory device of claim 35, wherein executing a second ESI collection application includes displaying the ESI collection wizard.
